(19) United States
(12) Patent Application Publication
(10) Pub. No.: US 2026/0313612 A1
(43) Pub. Date: Oct. 8, 2026

(54) METHOD AND APPARATUS FOR PAGING OPERATION IN MOBILE WIRELESS COMMUNICATION SYSTEM

(71) Applicant: SETLAB Co., LTD., Gyeonggi-do (KR)

(72) Inventor: Soenghun KIM, Gyeonggi-do (KR)

(21) Appl. No.: 19/632,448

(22) Filed: Mar. 30, 2026

(30) Foreign Application Priority Data
Apr. 7, 2025 (KR) 10-2025-0045041
Mar. 23, 2026 (KR) 10-2026-0051756

(51) Int. Cl. H04W 68/02; H04L 27/26

(52) U.S. Cl. CPC H04W 68/02; H04L 27/26025

(57) ABSTRACT

A terminal apparatus for adaptive paging reception in wireless communication systems is disclosed. The terminal comprises a transceiver and a controller configured to receive system information from a base station and monitor paging occasions based on condition-based paging occasion determination logic. When a network applies paging-adaptation and provides enhanced paging parameters, the terminal determines a starting monitoring occasion number based on a second parameter related to the first monitoring occasion, enabling condensed paging occasion operation for improved energy efficiency. When paging adaptation is not applied or only baseline parameters are provided, the terminal reverts to baseline paging occasion determination. This dual-mode operation enables seamless coexistence of legacy and enhanced paging schemes, minimizing energy waste in low-load cells while preserving congestion mitigation benefits in high-load scenarios and various network implementations.

### CROSS-REFERENCE TO RELATED APPLICATION

This application claims priority to and the benefit of Korean Patent Application Nos. 10-2025-0045041, filed on Apr. 7, 2025, and 10-2026-0051756, filed on Mar. 23, 2026. Each of the above documents is incorporated herein by reference in its entirety.

### BACKGROUND

### Technical Field

The present disclosure relates to paging operation in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability. In the advancement of 5G networks, one significant focus is improving network energy efficiency.

### SUMMARY

The present invention provides a terminal apparatus for adaptive paging reception in wireless communication systems that enables energy-efficient operation by supporting both baseline and enhanced paging occasion determination schemes. The terminal comprises a transceiver configured to transmit and receive radio signals, and a controller operatively coupled to the transceiver for managing paging monitoring operations.

According to the invention, the controller is configured to receive system information from a base station, where the system information includes at least a first parameter indicating the number of paging occasions and a first parameter specifying a paging frame offset. Based on the received system information and applicable conditions, the controller determines a starting monitoring occasion number for a specific set of consecutive monitoring occasions and monitors at least one monitoring occasion within that set.

The terminal implements condition-based paging occasion determination logic. When first specific conditions are fulfilled, the starting monitoring occasion number is determined based on a second parameter related to the first monitoring occasion. The first specific conditions require that the system information includes the second parameter related to the first monitoring occasion and that paging-adaptation is being applied by the network. Conversely, when second specific conditions are fulfilled, the starting monitoring occasion number is determined based on a first parameter related to the first monitoring occasion. The second specific conditions require at least that the system information includes the first parameter related to the first monitoring occasion.

This dual-mode operation enables the terminal to support both legacy dispersed paging occasion allocation schemes and enhanced condensed paging occasion schemes within the same network. When the network applies paging-adaptation and provides the second parameter, the terminal operates in an energy-efficient enhanced mode with condensed paging occasions. When paging-adaptation is not applied or when only the first parameter is provided, the terminal reverts to the baseline paging occasion determination scheme, ensuring backward compatibility with legacy network configurations.

By implementing this adaptive paging monitoring mechanism, the terminal achieves optimal energy consumption while maintaining seamless interoperability with both legacy and enhanced network deployments. The invention thereby addresses the technical problem of unnecessary energy waste in low-load cell scenarios while preserving the congestion mitigation benefits of dispersed paging in high-load scenarios, ultimately providing a flexible and efficient solution for diverse network deployment conditions.

### BRIEF DESCRIPTION OF THE DRAWINGS

FIG. 1 is a diagram illustrating the architecture of an 5G system and a NG-RAN;

FIG. 2 is a diagram illustrating a wireless protocol architecture in an 5G system;

FIG. 3 illustrates the overall operation of the UE and network.

FIG. 4 illustrates SS/PBCH block.

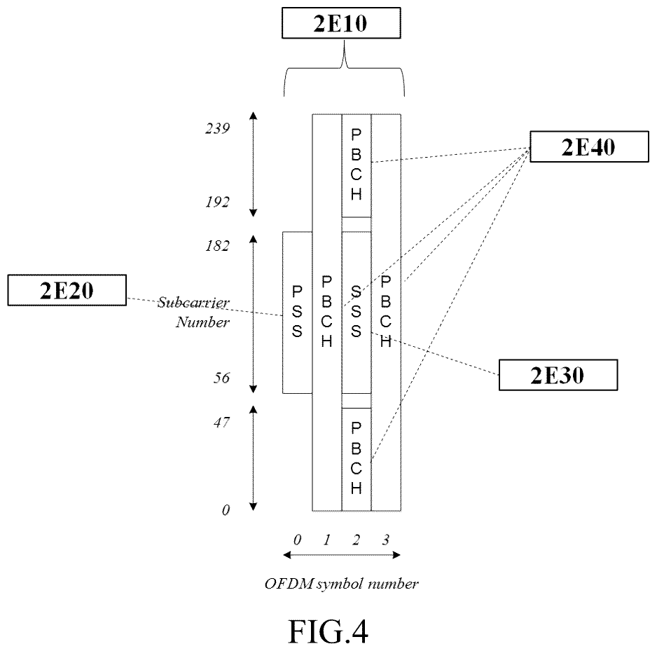

FIG. 5 illustrates enhanced paging scheme.

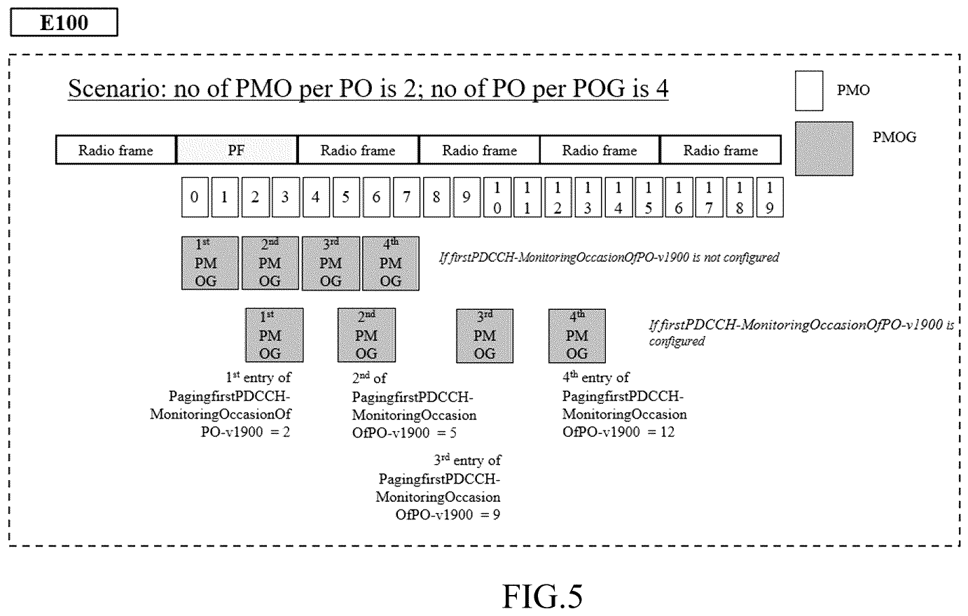

FIG. 6 illustrates the operation of the terminal and network.

FIG. 7 illustrates the operation of the terminal and network.

FIG. 8 is a diagram illustrating operations of the terminal.

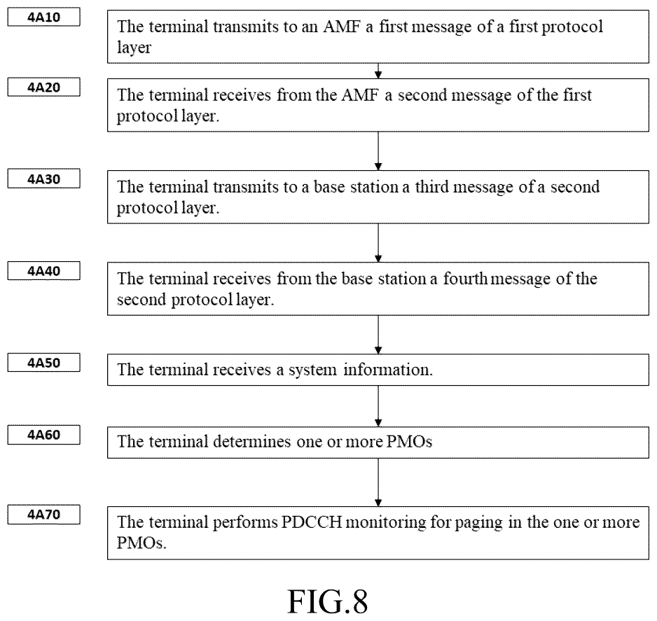

FIG. 9 is a block diagram illustrating the internal structure of a UE according to the disclosure.

FIG. 10 is a block diagram illustrating the internal structure of a base station according to the disclosure.

### DETAILED DESCRIPTION

To facilitate energy saving in network side, a feasible solution is to provide opportunities for turning off downlink transmission in base station. One example of the downlink transmission to be turned off is system information. System information is periodically transmitted to provide unspecified multiple terminals in a cell necessary information for access.

Under certain circumstances, transmission of such system information may not be necessary if access to the cell can be delayed. For example, if the geographical coverage of the cell is covered by another cell, terminal may camp on the other cell (e.g. anchor cell) first and then access to the cell (non-anchor cell) from the other cell, possibly based on assistance information achieved from the other cell.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

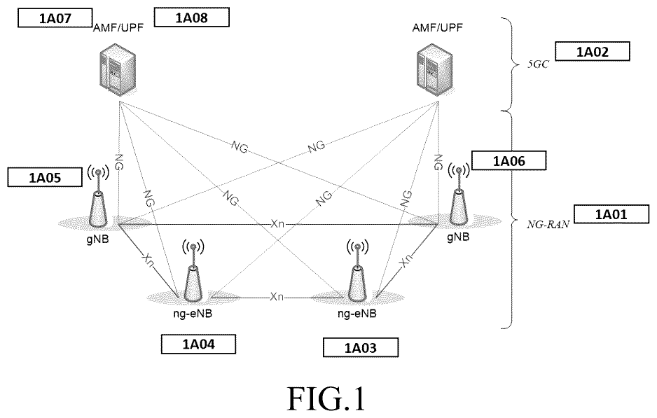

FIG. 1 is a diagram illustrating the architecture of an 5G system and a NG-RAN to which the disclosure may be applied.

5G system consists of NG-RAN 1A01 and 5GC 1A02. An NG-RAN node is either:
a gNB, providing NR user plane and control plane protocol terminations towards the UE; or
an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
Functions for Radio Resource Management such as Radio Bearer Control, Radio Admission Control, Connection Mobility Control, Dynamic allocation of resources to UEs in uplink, downlink and sidelink (scheduling); and
IP and Ethernet header compression, uplink data decompression and encryption of user data stream; and
Selection of an AMF at UE attachment when no routing to an MME can be determined from the information provided by the UE; and
Routing of User Plane data towards UPF; and
Scheduling and transmission of paging messages; and
Scheduling and transmission of broadcast information (originated from the AMF or O&M); and
Measurement and measurement reporting configuration for mobility and scheduling; and
Session Management; and
QoS Flow management and mapping to data radio bearers; and
Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

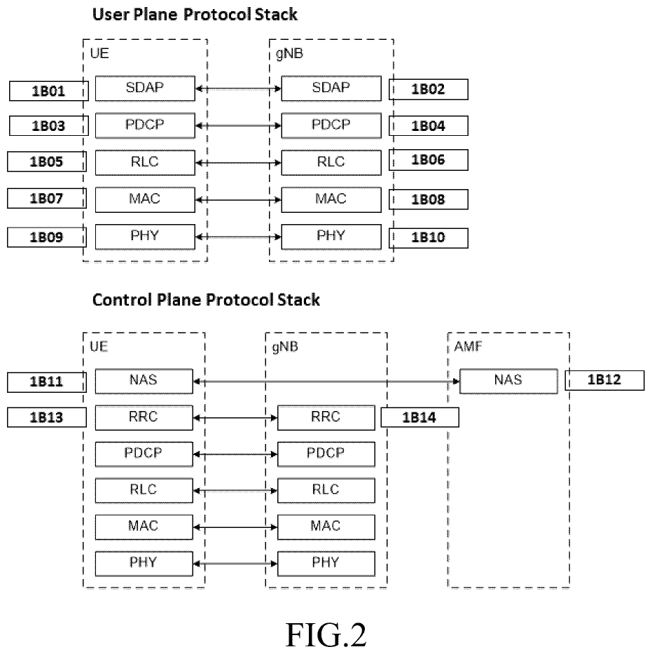

FIG. 2 is a diagram illustrating a wireless protocol architecture in an 5G system to which the disclosure may be applied.

The user plane protocol stack consists of SDAP 1B01 or 1B02, PDCP 1B03 or 1B04, RLC 1B05 or 1B06, MAC 1B07 or 1B08 and PHY 1B09 or 1B10. The control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

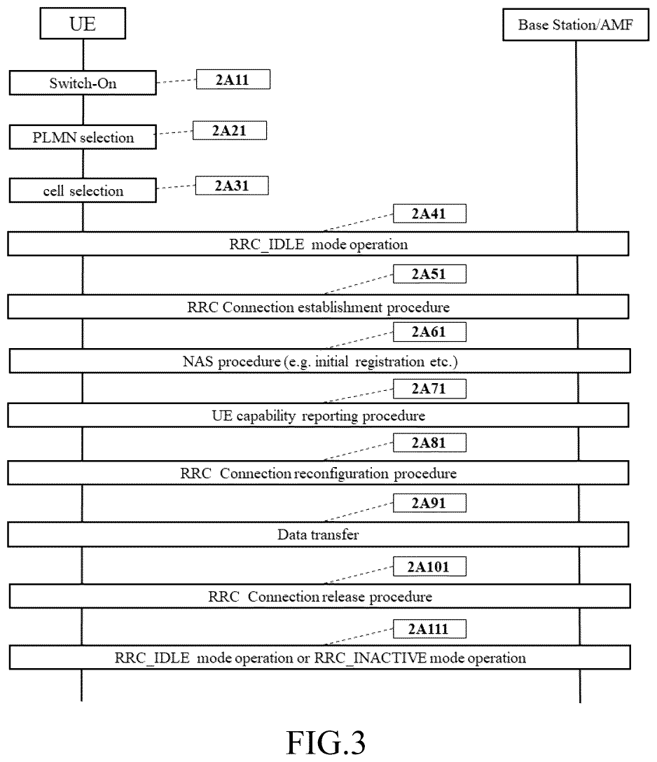

FIG. 3 illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform, e.g., NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

The Synchronization Signal and PBCH block (SSB) 2E10 consists of primary synchronization signals (PSS) 2E20 and secondary synchronization signals (SSS) 2E30, PSS and SSS occupies 1 symbol and 127 subcarriers. PBCH 2E40 spans across 3 OFDM symbols and 240 subcarriers. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Paging transmission with short periodicity consumes significant base station energy. NR system uses a paging transmission scheme that keeps base station transmitter awake by dispersing Paging Opportunities across time domain. It is a reasonable approach in a sense that random access congestion may occur otherwise.

Since various types of networks/cells have been deployed (and will be deployed), random access congestion may not be an issue in some cases (e.g. in low load cell where random access congestion may not occur), where “dispersing paging opportunities” may only consume network energy without tangible benefits.

By condensing paging opportunities in time domain, base station may turn off the receiver until the next paging opportunities that leads to network energy saving.

UE may support either only baseline PO determination scheme (dispersed multi-PO group) or enhanced PO determination scheme also (condensed multi-PO group or Single PO group).

For RAN paging, based on UE capability and base station capability, the base station transmits paging message for the UE according to the baseline scheme or enhanced scheme.

For CN paging, based on UE capability and base station capability and CN capability, the base station transmits paging message for the UE according to the baseline scheme or enhanced scheme.

### Baseline Paging Scheme and Enhanced Paging Scheme

Paging scheme and PO determination scheme are used interchangeably.

Enhanced paging scheme and NES paging scheme are used interchangeably.

Enhanced paging (transmission/scheme/reception) and NES paging (transmission/scheme/reception) are used interchangeably.

PTW is CN configured PTW if not stated otherwise.

Paging is either paging message or paging transmission or paging reception or paging scheme.

DRX cycle and DRX value and T are used interchangeably. “consist of” and “comprise” are used interchangeably.

NsExt and pagingAdaptation-NS are used interchangeably.

Enhanced paging scheme and paging-adaptation are used interchangeably.

T and T_cn are used interchangeably in case that the operation that concerns T is for CN-initiated paging.

T and T_ran are used interchangeably in case that the operation that concerns T is for RAN-initiated paging.

N is number of PFs per T. In UE perspective, there is only one PF per T. In NW perspective, there could be more than one PF per T. Multiple PFs per Tis beneficial in terms of load balancing. Multiple PFs per Tis harmful in terms of NW power saving.

N is controlled by nAndPagingFrameOffset and pagingAdaptationNAndPagingFrameOffset.

nAndPagingFrameOffset indicates one of [oneT, halfT, quarterT, oneEighthT, oneSixteenthT].

pagingAdaptationNAndPagingFrameOffset indicates one of [oneT, halfT, quarterT, oneEighthT, oneSixteenthT, one ThirtySecondT].

As the name of the parameters implies, oneT means N is equal to T (in number of radio frames), oneEighthT means N is equal to T/8 (e.g. if T is 256 radio frames, N is 32), one ThirtySecondT means that N is equal to T/32 (e.g. if T is 256 radio frames, N is 8) and so on.

Smaller N results in better NW power efficiency. Higher N results in better load balancing.

For UEs that do not support paging-adaptation scheme (paging-adaptation scheme), NW controls N by nAndPagingFrameOffset.

For UEs that support paging-adaptation scheme, NW controls N by pagingAdaptationNAndPagingFrameOffset.

### Definitions

TABLE 1

| CN paging | RAN paging |
|---|---|
| >: Initiated by CN/AMF | >: Initiated by GNB |
| >: Paging message comprises 5G-S-TMSI | >: Paging message comprises fullI-RNTI |
| >: Monitored and received by both UEs in >: | >: Monitored and received by UEs in |
| RRC_IDCLE and UEs in RRC_INACTIVE | RRC_INACTIVE |

TABLE 2

| Baseline paging | NES paging |
|---|---|
| Paging that is applied when a specific indication | Paging that is applied to a UE: |
| regarding NES paging is not comprised in a specific | >: when a specific indication regarding NES paging is |
| system information. | comprised in a specific system information; and |
| Paging that is applied to UEs that does not support | >: when the UE supports NES paging (UEs that are |
| NES paging (UEs that are not configured with NES | configured with NES paging). |
| paging). | Paging opportunities for a DRX cycle are condensed |
| Paging opportunities for a DRX cycle are dispersed | in a specific part of the DRX cycle. |
| over the DRX cycle. | |

### PTW:

Time period for a UE, in case that the UE operates in extended DRX, during which paging is transmitted
Configuration parameters for PTW are comprised in a NAS message

Paging opportunity for a UE during a DRX cycle consists of one or more PMOs or a PO

### PMO:

PDCCH monitoring occasion for paging;
A PMO consists of one or more consecutive symbols (indicated by monitoringSymbolsWithinSlot in SearchSpace IE corresponding to pagingSearchSpace);
A PMO resides in a slot;
The PMOs which do not overlap with UL symbols (determined according to tdd-UL-DL-ConfigurationCommon) are sequentially numbered from zero starting from the first PMO in the PF.

### PO/PMOG:

Paging Occasion/PMO Group
A set of consecutive PMOs;
A PO consists of one or more time slots (A PO may span across two or more slots);
A PO consists of S*X′ consecutive PMOs:
   S is the number of actual transmitted SSBs determined according to ssb-PositionsInBurst in SIB1;
   X is the nrofPDCCH-MonitoringOccasionPerSSB-InPO if configured or is equal to 1 otherwise;
   The [x*S+K]^{th} PMO in the PO corresponds to the K^{th} transmitted SSB;

### POG:

Paging Occasion Group;
A POG consist of Ns/NsExt consecutive POs;
A POG is associated with a reference point (e.g. a first symbol of a Paging Frame);
Each PO of the POG is indexed from 0 to Ns−1 sequentially;
One POG per DRX cycle.

### PF (or Reference Point):

Paging Frame;
A PF provides the reference point to determine starting point of one or more POs (the one or more POs that belong to the same POG);
The reference point to determine the starting point is the first PMO of a specific radio frame (e.g. PF)

T_CN: UE specific DRX value configured by upper layers (comprised in Registration Accept message).

T_RAN: UE specific DRX value configured by RRC (Comprised in RRCRelease).

T_E_CN: TeDRX_CN (comprised in Registration Accept message), extended DRX value/cycle for CN paging, T_eDRX_CN. Configured by Extended DRX parameters.

T_E_RAN: TeDRX_RAN (comprised in RRCRelease), extended DRX value/cycle for RAN paging, T_eDRX_RAN. Configured by ExtendedPagingCycle-r17

T_D: cell specific default DRX value broadcast in system information (SIB1).

N: number of total paging frames in T (or number of RPs in T)

PF_offset: offset used for PF determination

Ns: number of paging occasions for a PF (number of POs for a RP; number of POs of a POG)

UE_ID: 10 LSBs (if UE does not operate in eDRX) or 12 LSBs (if UE operates in eDRX) of 5G-S-TMSI of the UE. It is used to determine PF (RP) and PO index (PMOG index)

first_T, first_N: parameters/inputs that are used to determine the specific frame (PF) that contains the reference time point (reference PMO, first PMO).

Second_T, second_N: parameters/inputs that are used to determine PO index.

For UE in RRC_IDLE: first_T and second_T are identical/same; first_N and second_N are identical/same.

For UE in RRC_INACTIVE: first_T and second_T are different in specific cases; First_N and second_N are different in the specific cases; first_T and second_T are same in other cases. First_N and second_N are same in other cases.

In general, PMO/PO/PF are determined as below:
A DRX cycle of a UE consists of one or more RPs (N RPs);
A RP is associated with a POG (one or more consecutive POs);
A POG consists of one or more consecutive POs (Ns/NsExt POs);
A PO consists of one or more consecutive PMOs (S*X PMOs);
A DRX cycle consists of (N*Ns*S*X) PMOs;
   N instances of consecutive (Ns/NsExt*S*X) PMOs;
   N instances of consecutive Ns/NsExt POs;
UE determines a RP among N RPs:
   UE determines a PF; and
UE determines RP based on the determined PF;
UE determines a PO from one of more POs of the POG associated with the RP;
UE determines index of the PO to be monitored (i_s);
UE determines the time domain locations of PMOs of the PO to be monitored.
   If firstPDCCH-MonitoringOccasionOfPO is configured:
      the starting PDCCH monitoring occasion (PMO) number of (i_s+1)^{th} PO is the (i_s+1)^{th} value of the firstPDCCH-MonitoringOccasionOfPO parameter
   If firstPDCCH-MonitoringOccasionOfPO is not configured:
      The starting PMO number is equal to i_s*S*X.
   PMO number and the time domain starting point of the corresponding PMO is determined based on SearchSpace IE of pagingSearchSpace and tdd-UL-DL-ConfigurationCommon
UE monitors one or more PMOs of the determined PO based on RSRP of downlink pathloss reference (e.g. SSB).

The value included in firstPDCCH-MonitoringOccasionOfPO or firstPDCCH-MonitoringOccasionOfPOext indicates at which symbol is the first symbol of the first PMO of the corresponding PO.

For all paging schemes, T is determined as below.

T is DRX cycle/value of the UE that is used to determine RP and PO index.

T_E_CN and T_eDRX_CN are used interchangeably.

T_E_RAN and T_eDRX_RAN are used interchangeably.

UE specific DRX value configured by RRC is T_RAN.

UE specific DRX value configured by upper layers is T_CN.

If the UE does not operate in eDRX:
T is determined by the shortest of the UE specific DRX value configured by RRC (if any), the UE specific DRX value configured by upper layers (if any), and a default DRX value broadcast in system information. For L2 U2N Relay UE, T for a L2 U2N Remote UE is determined by the shortest of the UE specific DRX value provided in PC5-RRC signalling and a default DRX value broadcast in system information.

In RRC_IDLE state, if the UE operates in eDRX and eDRX is configured by upper layers, i.e., T_eDRX_CN:
If T_eDRX_CN is no longer than 1024 radio frames:
   T=T_eDRX_CN;
else:
   During CN configured PTW, T is determined by the shortest of UE specific DRX value, if configured by upper layers, and the default DRX value broadcast in system information.

In RRC_INACTIVE state, if the UE operates in eDRX and eDRX is configured by RRC, i.e., T_eDRX_RAN (if any), and upper layers, i.e., T_eDRX_CN:
If both T_eDRX_CN and used T_eDRX_RAN are no longer than 1024 radio frames, T=min {T_eDRX_RAN, T_eDRX_CN}.
If T_eDRX_CN is no longer than 1024 radio frames and no T_eDRX_RAN is configured or used, T is determined by the shortest of UE specific DRX value configured by RRC and T_eDRX_CN.
If T_eDRX_CN is longer than 1024 radio frames:
If T_eDRX_RAN is not configured or used:
   During CN configured PTW, T is determined by the shortest of the UE specific DRX value configured by RRC, the UE specific DRX value configured by upper layers (if any), and a default DRX value broadcast in system information. Outside the CN configured PTW, T is determined by the UE specific DRX value configured by RRC;
   else if used T_eDRX_RAN is no longer than 1024 radio frames:
      During CN configured PTW, T is determined by the shortest of the UE specific DRX value, if configured by upper layers and T_eDRX_RAN, and a default DRX value broadcast in system information. Outside the CN configured PTW, T is determined by T_eDRX_RAN;
   else if used T_eDRX_RAN is longer than 1024 radio frames:
      During the overlapped part of CN configured PTW and RAN configured PTW, T is determined by the shortest of the UE specific DRX value configured by RRC, the UE specific DRX value configured by upper layers (if any), and a default DRX value broadcast in system information;
      During CN configured PTW and outside RAN configured PTW, T is determined by the shortest of the UE specific DRX value configured by upper layers (if any), and a default DRX value broadcast in system information;
      Outside CN configured PTW and during RAN configured PTW, T is determined by the UE specific DRX value configured by RRC.

E100 is an exemplary illustration of enhanced scheme when 4 POs per POG is configured.

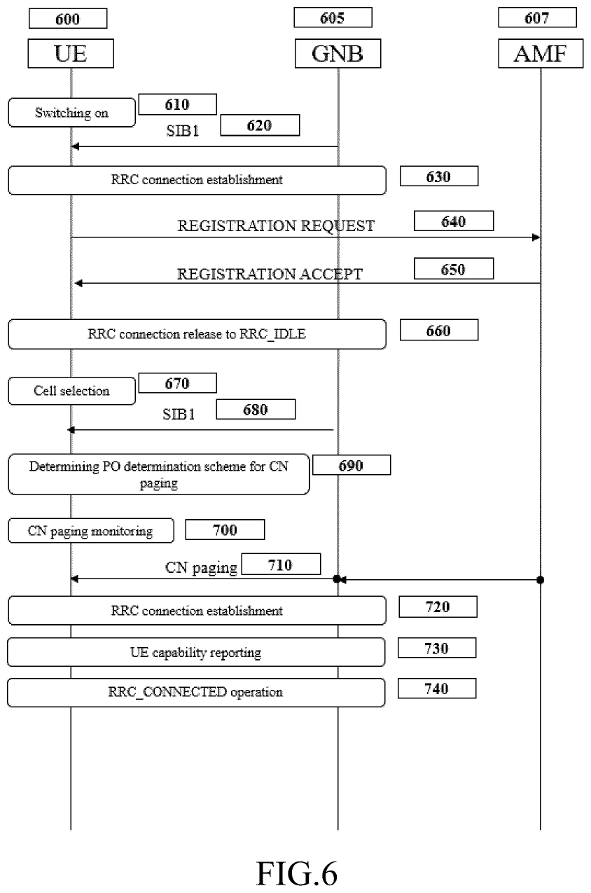

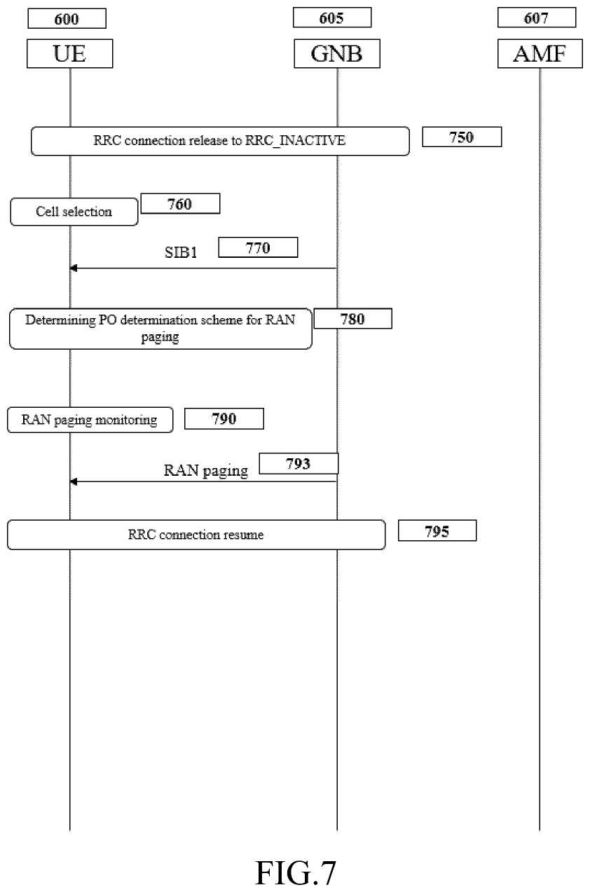

FIG. 6 and FIG. 7 illustrate operations for paging transmission and paging receptions.

At 610, upon switching on, UE performs PLMN selection and cell selection.

At 620, UE receives MIB and SIB1 in the selected cell. UE determines whether the cell is barred or not. If the cell is not barred, UE proceeds with the RRC connection establishment procedure. If the cell is barred, UE selects another cell.

At 630, UE and GNB perform RRC connection establishment procedure. UE transmits a RRCSetupRequest, receives a RRCSetup and transmits a RRCSetupComplete. UE and GNB establishes SRB1.

At 640, UE transmits GNB ULInformationTransfer that contains REGISTRATION REQUEST message. UE includes in the message an IE that indicates UE supports the paging-adaptation scheme (paging-Adaptation) for NES. GNB forwards REGISTRATION REQUEST message to AMF.

At 650, AMF transmits REGISTRATION ACCEPT to the GNB. GNB transmits to the UE DLInformation Transfer that includes REGISTRATION ACCEPT.

### Registration Accept Includes:

5G-GUTI that includes 5G-S-TMSI
Information that the paging-adaptation scheme for NES is allowed in the Tracking Area. If allowed, UE applies the paging-adaptation scheme in a cell if the cell supports/allows the paging-adaptation scheme for NES.

At 660, UE and GNB perform RRC connection release for state transition to RRC_IDLE. After completion of NAS registration procedure, GNB may release RRC connection by transmitting RRCRelease.

At 670, UE performs cell selection to find a suitable cell to camp on.

At 680, UE receives MIB and SIB1 in the selected cell. UE determines that the cell is suitable. UE determines whether paging-adaptation scheme for NES is applied in the cell. If SIB1 includes pagingAdaptationNAndPagingFrameOffset and pagingAdaptation-NS, UE consider paging-adaptation scheme for CN-initiated paging is supported/allowed in the cell.

At 690, UE determines PO determination scheme for CN-initiated paging.

UE determines to use baseline paging scheme in case that:
UE has not reported/indicated to AMF, via REGISTRATION REQUEST, that UE supports paging-adaptation scheme or UE has not received an indication from AMF, via REGISTRATION ACCEPT, that paging-adaptation scheme is allowed/supported; or
UE has reported/indicated to AMF that UE supports paging-adaptation scheme and UE has received an indication from AMF that paging-adaptation scheme is allowed/supported and SIB1 does not include pagingAdaptationNAndPagingFrameOffset and pagingAdaptation-NS.

UE determines to use paging-adaptation scheme in case that:
UE has reported/indicated to AMF that UE supports paging-adaptation scheme and UE has received an indication from AMF that paging-adaptation scheme is allowed/supported and SIB1 includes pagingAdaptationNAndPagingFrameOffset and pagingAdaptation-NS.

At 700, UE performs paging monitoring for CN-initiated paging based on the determined paging scheme.

UE performs <paging monitoring operation in RRC_IDLE when paging-adaptation is not applied> if paging-adaptation is not applied in the cell. (or if UE determines to use baseline paging scheme)

UE performs <paging monitoring operation in RRC_IDLE when paging-adaptation is applied> if paging-adaptation is applied in the cell (or if UE determines to use paging-adaptation scheme).

At 710, GNB receives a paging message for the UE from AMF. GNB determines to use paging-adaptation in case that:
the paging message includes a parameter indicating that the UE support paging-adaptation; and
the cell supports paging-adaptation.

GNB transmits the paging message to the UE. GNB transmits a paging-DCI in all PMOs of the-PO. GNB transmits PDSCH that contains the paging message according to scheduling information in the paging-DCI. The paging message includes 5G-S-TMSI of the UE.

At 720, UE performs with GNB RRC connection establishment procedure in response to that the paging message includes 5G-S-TMSI of the UE. UE proceeds to 730. If the paging message does not include 5G-S-TMSI of the UE, UE continues paging monitoring operation for CN-initiated paging.

At 730, UE receives UECapabilityEnquiry and transmits UECapabilityInformation. UECapabilityInformation may include pagingAdaptationSupportInactive field. This field indicates that the UE supports paging-adaptation scheme for both CN-initiated paging and RAN-initiated paging.

At 740, UE and GNB perform RRC_CONNECTED operations.

GNB determines configurations for the UE based on reported capability and cell status. GNB transmits to UE RRCReconfiguration to deliver the determined configurations. UE and GNB perform RRC_CONNECTED operations such as data transfer and mobility.

At 750, at some point of time GNB decides to release the RRC connection and puts the UE to RRC_INACTIVE state. UE receives from GNB RRCRelease. The RRCRelease includes suspendConfig field that contains various IEs related to RAN-initiated paging.

At 760, UE performs cell selection and performs state transition to RRC_INACTIVE.

At 770, UE receives MIB and SIB1 in the selected cell. UE determines that the cell is suitable. UE determines whether paging-adaptation scheme for NES is applied in the cell.

If SIB1 includes pagingAdaptation-NS and pagingAdaptationNAndPagingFrameOffset, UE consider paging-adaptation scheme is supported/allowed in the cell for UEs in RRC_INACTIVE.

At 780, UE determines PO determination scheme for RAN-initiated paging and CN-initiated paging. UE uses the same paging scheme for RAN-initiated paging and CN-initiated paging.

UE uses baseline paging scheme for both RAN-initiated paging and CN-initiated paging in case that the paging-adaptation is not applied in the cell (or UE determines to use paging-adaptation scheme).

UE uses paging-adaptation scheme for both RAN-initiated paging and CN-initiated paging in case that the paging-adaptation is applied in the cell (or UE determines to use paging-adaptation scheme).

At 790, UE performs <paging monitoring operation in RRC_INACTIVE when paging-adaptation is not applied> if the paging-adaptation is not applied in the cell. UE performs <paging monitoring operation in RRC_INACTIVE when paging-adaptation is applied> if the paging-adaptation is applied in the cell (or UE determines to use paging-adaptation in the cell).

UE may perform followings.
UE determines T_cn, N_cn and i_s_cn; and
UE determines T_ran and N_ran and i_s_ran,
if used extended DRX value configured by upper layers (e.g. T_E_CN) is no longer than 1024 radio frames,
   the UE shall use the same i_s as for RRC_IDLE state (e.g. UE uses i_s_cn for both CN-initiated paging and RAN-initiated paging)
if used extended DRX value configured by upper layers (e.g. T_E_CN) is longer than 1024 radio frames,
   the UE shall use the same i_s as for RRC_IDLE state during CN PTW, that is:
      the UE shall use T_ran to determine T; AND
   UE uses i_s_cn for both CN-initiated paging and RAN-initiated paging during CN PTW;
   the UE shall use i_s_ran for RAN-initiated paging outside CN PTW that is:
      the UE shall use T_ran to determine T; and
      UE uses i_s_ran;

At 793, GNB determines to page UE.

GNB transmits the paging message to the UE. GNB transmits a paging-DCI in all PMOs of the-PO. GNB transmits PDSCH that contains the paging message according to scheduling information in the paging-DCI. The paging message includes I-RNTI of the UE.

At 795, UE performs with GNB RRC connection resume procedure in response to that the paging message includes I-RNTI of the UE. UE initiate a procedure to resume RRC connection. If the paging message does not include 5G-S-TMSI of the UE, UE continues paging monitoring operation for CN-initiated paging and RAN-initiated paging.

In case that the paging message comprises 5G-S-TMSI of the UE, UE performs cell selection, <paging monitoring operation in RRC_IDLE when paging-adaptation is not applied> or <paging monitoring operation in RRC_IDLE when paging-adaptation is applied>, system information acquisition and RRC connection establishment procedure.

### Paging Monitoring

To perform paging monitoring, UE and network use same T. There are many factors/parameters that affect T, UE and network choose T properly based on given configurations.

### CASEs to be Considered

To facilitate the discussion, following cases are defined.
CASE1: UE is operating in eDRX for CN paging;
CASE2: UE is not operating in eDRX for CN paging;
CASE3: UE is operating in eDRX with T_RAN_E (>1024) for RAN paging;
CASE4: UE is operating in eDRX with T_RAN_E (=<1024) for RAN paging;
CASE5: UE is not operating in eDRX for RAN paging.

For UE in RRC_IDLE, CASE1 and CASE2 are valid. UE determines the CASE as in table below.

TABLE 3

| UE is configured | eDRX-AllowedIdle | | |
|---|---|---|---|
| for eDRX by | is signalled | | |
| upper layers | in SIB1 | CASE | raw |
| Yes | Yes | CASE1 | 1 |
| Yes | No | CASE2 | 2 |
| No | Yes | CASE2 | 3 |
| No | No | CASE2 | 4 |

UE in RRC_INACTIVE determines the CASE as in table below.

TABLE 4

| | eDRX- | | eDRX- | | |
|---|---|---|---|---|---|
| UE is configured | AllowedInactive-r18 | UE is configured | AllowedInactive-r17 | | |
| for eDRX by ran- | is signalled | for eDRX by ran- | is signalled | | |
| ExtendedPagingCycle-r18 | in SIB1 | ExtendedPagingCycle-r17 | in SIB1 | CASE | Raw |
| Y | Y | Y | Y | NA | 1 |
| Y | Y | Y | N | NA | 2 |
| Y | Y | N | Y | CASE3 | 3 |
| Y | Y | N | N | CASE3 | 4 |
| Y | N | Y | Y | NA | 5 |
| Y | N | Y | N | NA | 6 |
| Y | N | N | Y | CASE5 | 7 |
| Y | N | N | N | CASE5 | 8 |
| N | Y | Y | Y | CASE4 | 9 |
| N | Y | Y | N | CASE5 | 10 |
| N | Y | N | Y | CASE5 | 11 |
| N | Y | N | N | CASE5 | 12 |
| N | N | Y | Y | CASE4 | 13 |
| N | N | Y | N | CASE5 | 14 |
| N | N | N | Y | CASE5 | 15 |
| N | N | N | N | CASE5 | 16 |

A UE in RRC_INACTIVE can be in a combination of cases as in table below.

TABLE 5

| operating in eDRX | operating in eDRX | |
|---|---|---|
| for CN paging | for RAN paging | Description |
| Yes | Yes | CASE1 + CASE 3/4 |
| Yes | No | CASE1 + CASE5 |
| No | Yes | Not possible |
| No | No | CASE2 + CASE5 |

T is determined as in table below.

TABLE 6

| | | T | Raw |
|---|---|---|---|
| UE does not operate | CASE2 or | Shortest of | 1 |
| in eDRX | CASE2 + CASE5 | [T_RAN, T_CN, T_D] | |
| UE in RRC_IDLE | CASE1 | [T_E_CN] | 2 |
| operates in eDRX; | T_E_CN =< 1024 | | |
| | CASE1 | During CN configured PTW | 3 |
| | T_E_CN > 1024; | Shortest of | |
| | During CN_PTW | [T_CN, T_D] | |
| | | Outside the CN configured PTW, | |
| | | UE does not monitor paging and T is not | |
| | | used | |
| UE in | CASE1 + CASE3 | Shortest of | 4 |
| RRC_INACTIVE | T_E_CN =< 1024; | [T_E_RAN, T_E_CN] | |
| operates in eDRX; | T_E_RAN =< 1024 | | |
| | CASE1 + CASE3 | During CN configured PTW, | 5 |
| | T_E_CN > 1024; | Shortest of | |
| | T_E_RAN =< 1024 | [T_CN, T_E_RAN, T_D]. | |
| | | Outside the CN configured PTW, | |
| | | [T_E_RAN] | |
| | CASE1 + CASE5 | Shortest of | 6 |
| | T_E_CN =< 1024; | [T_RAN, T_E_CN] | |
| | Not operating in eDRX | | |
| | for RAN paging | | |
| | CASE1 + CASE5 | During CN configured PTW, | 7 |
| | T_E_CN > 1024; | Shortest of | |
| | Not operating in eDRX | [T_RAN, T_CN, T_D]. | |
| | for RAN paging | Outside the CN configured PTW, | |
| | | [T_RAN]. | |
| | CASE1 + CASE4 | During the overlapped part of CN | 8 |
| | T_E_CN > 1024; | configured PTW and RAN configured PTW, | |
| | T_E_RAN > 1024 | Shortest of | |
| | | [T_RAN, T_CN, T_D]. | |
| | | During CN configured PTW and outside | |
| | | RAN configured PTW, | |
| | | Shortest of | |
| | | [T_CN, T_D]. | |
| | | Outside CN configured PTW and during | |
| | | RAN configured PTW | |
| | | [T_RAN] | |
| | | Outside CN configured PTW and | |
| | | outside RAN configured PTW | |
| | | UE does not monitor paging and T is not | |
| | | used | |

first_T, first_N: parameters/inputs that are used to determine the specific frame that contains the reference time point (reference PMO, first PMO).

Second_T, second_N: parameters/inputs that are used to determine PO index.

For UE in RRC_IDLE: first_T and second_T are identical/same; first_N and second_N are identical/same.

For UE in RRC_INACTIVE: first_T and second_T are different in specific cases; First_N and second_N are different in the specific cases; first_T and second_T are same in other cases. First_N and second_N are same in other cases.

NsExt and pagingAdaptation-NS are used interchangeably.

Enhanced paging scheme and paging-adaptation are used interchangeably.

T and T_cn are used interchangeably in case that the operation that concerns T is for CN-initiated paging.

T and T_ran are used interchangeably in case that the operation that concerns T is for RAN-initiated paging.

N is number of PFs per T. In UE perspective, there is anyway only one PF per T. In NW perspective, there could be more than one PF per T. Multiple PFs per T is beneficial in terms of load balancing. Multiple PFs per Tis harmful in terms of NW power saving.

N is controlled by nAndPagingFrameOffset and pagingAdaptationNAndPagingFrameOffset.

nAndPagingFrameOffset indicates one of [oneT, halfT, quarterT, oneEighthT, oneSixteenthT].

pagingAdaptationNAndPagingFrameOffset indicates one of [oneT, halfT, quarterT, oneEighthT, oneSixteenthT, oneThirtySecondT].

As the name of the parameters implies, oneT means N is equal to T (in number of radio frames), oneEighthT means N is equal to T/8 (e.g, if T is 256 radio frames, N is 32), one ThirtySecondT means that N is equal to T/32 (e.g. if T is 256 radio frames, N is 8) and so on.

Smaller N results in better NW power efficiency. Higher N results in better load balancing.

For UEs that do not support paging-adaptation scheme (paging-adaptation scheme), NW controls N by nAndPagingFrameOffset.

For UEs that support paging-adaptation scheme, NW controls N by pagingAdaptationNAndPagingFrameOffset.

<Paging Monitoring Operation in RRC_IDLE when Paging-Adaptation is not Applied>
UE monitors the-PO every T_cn.
UE monitors the-PO for CN-initiated paging.
T_cn and i_s are determined according to raw 1~raw 3 of table 7.
The-PF is determined based on T_cn and PF_offset.
PF_offset is determined based on nAndPagingFrameOffset.
Starting PMO number of the-PO is determined based on i_s and firstPDCCH-MonitoringOccasionOfPO or firstPDCCH-MonitoringOccasionOfPO-v1710.
   in case that the cell provides firstPDCCH-MonitoringOccasionOfPO and the cell is in one of case1~case8;
      UE determines that the starting PDCCH monitoring occasion number of (i_s+1)^{th} PO is the (i_s+1)^{th} value of the firstPDCCH-MonitoringOccasionOfPO;
   in case that the cell provides firstPDCCH-MonitoringOccasionOfPO-v1710 and the cell is in case9 or case10;
      UE determines that the starting PDCCH monitoring occasion number of (i_s+1)^{th} PO is the (i_s+1)^{th} value of the firstPDCCH-MonitoringOccasionOfPO-v1710;
   in case that the cell does not provide firstPDCCH-MonitoringOccasionOfPO and the cell is in one of case1~case8; or
   in case that the cell does not provide firstPDCCH-MonitoringOccasionOfPO-v1710 and the cell is in one of case9 or case10,
      UE determines that the starting PDCCH monitoring occasion number of (i_s+1)^{th} PO is the i_s*S*X;
The-PO consists of S*X PMOs (starting PMO and (S*X−1) consecutive PMOs).
UE monitors one or more PMOs of the-PO.
   <Paging Monitoring Operation in RRC_IDLE when Paging-Adaptation is Applied>
UE monitors one or more PMOs of the-PO every T_cn.
UE monitors one or more PMOs for CN-initiated paging.
T_cn and i_s are determined according to raw 1~raw 3 of table 8.
The-PF is determined based on T_cn and PF_offset.
PF_offset is determined based on pagingAdaptationNAndPagingFrameOffset.
Starting PMO number of The-PO is determined based on i_s and firstPDCCH-MonitoringOccasionOfPO-v1900.
   in case that the cell provides firstPDCCH-MonitoringOccasionOfPO-v1900;
      UE determines that the starting PDCCH monitoring occasion number of (i_s+1)th PO is the (i_s+1)th value of the firstPDCCH-MonitoringOccasionOfPO-v1900;
   in case that the cell does not provide firstPDCCH-MonitoringOccasionOfPO-v1900,
      UE determines that the starting PDCCH monitoring occasion number of (i_s+1)^{th} PO is the i_s*S*X;
The-PO consists of S*X PMOs (starting PMO and (S*X−1) consecutive PMOs).
UE monitors one or more PMOs of the-PO.
   <Paging Monitoring Operation in RRC_INACTIVE when Paging-Adaptation is not Applied>
UE monitors the-PO every T_ran.
UE monitors the-PO for CN-initiated paging and RAN-initiated paging.
T_ran and i_s are determined according to raw 1, raw 4~raw 8 of table 7.
i_s is i_s_cn or i_s_ran as shown in table 7.
The-PF is determined based on T_ran and PF_offset.
PF_offset is determined based on nAndPagingFrameOffset.
Starting PMO number of The-PO is determined based on i_s and firstPDCCH-MonitoringOccasionOfPO or firstPDCCH-MonitoringOccasionOfPO-v1710.
   in case that the cell provides firstPDCCH-MonitoringOccasionOfPO and the cell is in one of case1~case8;
      UE determines that the starting PDCCH monitoring occasion number of (i_s+1)th PO is the (i_s+1)th value of the firstPDCCH-MonitoringOccasionOfPO;
   in case that the cell provides firstPDCCH-MonitoringOccasionOfPO-v1710 and the cell is in case9 or case10;
      UE determines that the starting PDCCH monitoring occasion number of (i_s+1)th PO is the (i_s+1)th value of the firstPDCCH-MonitoringOccasionOfPO-v1710;
   in case that the cell does not provide firstPDCCH-MonitoringOccasionOfPO and the cell is in one of case1~case8; or
   in case that the cell does not provide firstPDCCH-MonitoringOccasionOfPO-v1710 and the cell is in one of case9 or case10,
      UE determines that the starting PDCCH monitoring occasion number of (i_s+1)th PO is the i_s*S*X;
The-PO consists of S*X PMOs (starting PMO and (S*X−1) consecutive PMOs).
UE monitors one or more PMOs of the-PO.
   <Paging Monitoring Operation in RRC_INACTIVE when Paging-Adaptation is Applied>
UE monitors the-PO every T_ran.
UE monitors the-PO for CN-initiated paging and RAN-initiated paging.
T_ran and i_s are determined according to raw 1, raw 4~raw 8 of table 8.
   i_s is i_s_cn or i_s_ran as shown in table 8.
The-PF is determined based on T_ran and PF_offset.
PF_offset is determined based on nAndPagingFrameOffset.
Starting PMO number of The-PO is determined based on i_s and firstPDCCH-MonitoringOccasionOfPO-v1900.
   in case that the cell provides firstPDCCH-MonitoringOccasionOfPO-v1900;
      UE determines that the starting PDCCH monitoring occasion number of (i_s+1)th PO is the (i_s+1)th value of the firstPDCCH-MonitoringOccasionOfPO-v1900;
   in case that the cell does not provide firstPDCCH-MonitoringOccasionOfPO-v1900,
      UE determines that the starting PDCCH monitoring occasion number of (i_s+1)th PO is the i_s*S*X;
The-PO consists of S*X PMOs (starting PMO and (S*X−1) consecutive PMOs).
UE monitors one or more PMOs of the-PO.

The PO to be monitored by the UE is denoted as the-PO. The PF that is associated with the-PO is denoted as the-PF. The-PO and (i_s)th PO is used interchangeably.

<T and i_s when Paging-Adaptation is not Applied>

TABLE 7

| | | T & i_s | Raw |
|---|---|---|---|
| UE does not operate | CASE2 or | T = T_cn = Shortest of | 1 |
| in eDRX | CASE2 + CASE5 | [T_RAN, T_CN, T_D]; | |
| | | i_s = i_s_cn = f (T_cn, Ns) | |
| UE in RRC_IDLE | CASE1 | T = T_cn = [T_E_CN]; | 2 |
| operates in eDRX; | T_E_CN =< 1024 | i_s = i_s_cn = f (T_cn, Ns) | |
| | CASE1 | During CN configured PTW | 3 |
| | T_E_CN > 1024; | T = T_cn = Shortest of | |
| | During CN_PTW | [T_CN, T_D]; | |
| | | i_s = i_s_cn = f (T_cn, Ns) | |
| | | Outside the CN configured PTW, | |
| | | UE does not monitor paging and | |
| | | T is not used | |
| UE in | CASE1 + CASE3 | T = T_ran = Shortest of | 4 |
| RRC_INACTIVE | T_E_CN =< 1024; | [T_E_RAN, T_E_CN]; | |
| operates in eDRX; | T_E_RAN =< 1024 | i_s = i_s_cn = f (T_cn, Ns) | |
| UE uses T_ran to | CASE1 + CASE3 | During CN configured PTW, | 5 |
| determine PF for both | T_E_CN > 1024; | T = T_ran = Shortest of | |
| RAN-initiated paging | T_E_RAN =< 1024 | [T_CN, T_E_RAN, T_D]; | |
| and CN-initiated | | i_s = i_s_cn = f (T_cn, Ns) | |
| paging | | Outside the CN configured PTW, | |
| | | T = T_ran = [T_E_RAN]; | |
| | | i_s = i_s_ran = f (T_ran, Ns) | |
| | CASE1 + CASE5 | T = T_ran = Shortest of | 6 |
| | T_E_CN =< 1024; | [T_RAN, T_E_CN]; | |
| | Not operating in eDRX | i_s = i_s_cn = f (T_cn, Ns) | |
| | for RAN paging | | |
| | CASE1 + CASE5 | During CN configured PTW, | 7 |
| | T_E_CN > 1024; | T = T_ran = Shortest of | |
| | Not operating in eDRX | [T_RAN, T_CN, T_D]; | |
| | for RAN paging | i_s = i_s_cn = f (T_cn, Ns) | |
| | | Outside the CN configured PTW, | |
| | | T = T_ran = [T_RAN]. | |
| | | i_s = i_s_ran = f (T_ran, Ns) | |
| | CASE1 + CASE4 | During the overlapped part of CN | 8 |
| | TE_CN > 1024; | configured PTW and RAN configured PTW, | |
| | T_E_RAN > 1024 | T = T_ran = Shortest of | |
| | | [T_RAN, T_CN, T_D]; | |
| | | i_s = i_s_cn = f (T_cn, Ns) | |
| | | During CN configured PTW and | |
| | | outside RAN configured PTW, | |
| | | T = T_ran = Shortest of | |
| | | [T_CN, T_D]; | |
| | | i_s = i_s_cn = f (T_cn, Ns) | |
| | | Outside CN configured PTW and | |
| | | during RAN configured PTW | |
| | | T = T_ran = [T_RAN]; | |
| | | i_s = i_s_ran = f (T_ran, Ns) | |
| | | Outside CN configured PTW and | |
| | | outside RAN configured PTW | |
| | | UE does not monitor paging | |
| | | and T is not used | |

<T and i_s when Paging-Adaptation is Applied>

TABLE 8

| | | T & i_s | Raw |
|---|---|---|---|
| UE does not operate | CASE2 or | T_cn = Shortest of | 1 |
| in eDRX | CASE2 + CASE5 | [T_RAN, T_CN, T_D]; | |
| | | i_s = i_s_cn = f (T_cn, NsExt) | |
| UE in RRC_IDLE | CASE1 | T_cn = [T_E_CN]; | 2 |
| operates in eDRX; | T_E_CN =< 1024 | i_s = i_s_cn = f (T_cn, NsExt) | |
| | CASE1 | During CN configured PTW | 3 |
| | T_E_CN > 1024; | T_cn = Shortest of | |
| | During CN_PTW | [T_CN, T_D]; | |
| | | i_s = i_s_cn = f (T_cn, NsExt) | |
| | | Outside the CN configured PTW, | |
| | | UE does not monitor paging | |
| | | and T is not used | |
| UE in | CASE1 + CASE3 | T_ran = Shortest of | 4 |
| RRC_INACTIVE | T_E_CN =< 1024; | [T_E_RAN, T_E_CN]; | |
| operates in eDRX; | T_E_RAN =< 1024 | i_s = i_s_cn = f (T_cn, NsExt) | |
| UE uses T_ran to | CASE1 + CASE3 | During CN configured PTW, | 5 |
| determine PF for both | T_E_CN > 1024; | T_ran = Shortest of | |
| RAN-initiated paging | T_E_RAN =< 1024 | [T_CN, T_E_RAN, T_D]; | |
| and CN-initiated | | i_s = i_s_cn = f (T_cn, NsExt) | |
| paging | | Outside the CN configured PTW, | |
| | | T_ran = [T_E_RAN]; | |
| | | i_s = i_s_ran = f (T_ran, NsExt) | |
| | CASE1 + CASE5 | T_ran = Shortest of | 6 |
| | T_E_CN =< 1024; | [T_RAN, T_E_CN]; | |
| | Not operating in eDRX | i_s = i_s_cn = f (T_cn, NsExt) | |
| | for RAN paging | | |
| | CASE1 + CASE5 | During CN configured PTW, | 7 |
| | T_E_CN > 1024; | T_ran = Shortest of | |
| | Not operating in eDRX | [T_RAN, T_CN, T_D]; | |
| | for RAN paging | i_s = i_s_cn = f (T_cn, NsExt) | |
| | | Outside the CN configured PTW, | |
| | | T_ran = [T_RAN]. | |
| | | i_s = i_s_ran = f (T_ran, NsExt) | |
| | CASE1 + CASE4 | During the overlapped part of CN | 8 |
| | T_E_CN > 1024; | configured PTW and RAN configured PTW, | |
| | T_E_RAN > 1024 | T_ran = Shortest of | |
| | | [T_RAN, T_CN, T_D]; | |
| | | i_s = i_s_cn = f (T_cn, NsExt) | |
| | | During CN configured PTW and | |
| | | outside RAN configured PTW, | |
| | | T_ran = Shortest of | |
| | | [T_CN, T_D]; | |
| | | i_s = i_s_cn = f (T_cn, NsExt) | |
| | | Outside CN configured PTW and | |
| | | during RAN configured PTW | |
| | | T_ran = [T_RAN]; | |
| | | i_s = i_s_ran = f (T_ran, NsExt) | |
| | | Outside CN configured PTW and | |
| | | outside RAN configured PTW | |
| | | UE does not monitor paging | |
| | | and T is not used | |

### <Determining Whether Paging-Adaptation is Applied in the Cell>

paging-adaptation is not applied in the cell in case that:
UE does not support paging-adaptation scheme; or
UE supports paging-adaptation scheme but SIB1 of the cell does not include pagingAdaptationNAndPagingFrameOffset and pagingAdaptation-NS.

paging-adaptation is applied in the cell in case that:
UE supports paging-adaptation scheme; and
SIB1 does include pagingAdaptationNAndPagingFrameOffset and pagingAdaptation-NS.

UE supports paging-adaptation scheme in case that:
for CN-initiated paging,
   UE has reported/indicated to AMF that UE supports paging-adaptation scheme.
for RAN-initiated paging,
   UE has reported/indicated to AMF that UE supports paging-adaptation scheme; and
   UE has reported/indicated to GNB that UE supports paging-adaptation scheme.
      firstPDCCH-MonitoringOccasionOfPO

firstPDCCH-MonitoringOccasionOfPO, firstPDCCH-MonitoringOccasionOfPO-v1700 and firstPDCCH-MonitoringOccasionOfPO-v1900 field point out the first PDCCH monitoring occasion for paging of each PO of the PF. firstPDCCH-MonitoringOccasionOfPO, firstPDCCH-MonitoringOccasionOfPO-v1700 and firstPDCCH-MonitoringOccasionOfPO-v1900 field are collectively denoted as firstPDCCH-MonitoringOccasionOfPO-xx in this disclosure.

The PDCCH monitoring occasion for paging is configured by pagingSearchSpace. The PDCCH monitoring occasion for paging can be configured in any symbol, the granularity of the firstPDCCH-MonitoringOccasionOfPO-xx is PDCCH monitoring occasion (equivalently symbol).

Depending on the value signaled in nAndPagingFrameOffset/pagingAdaptationNAndPagingFrameOffset and SCS of the concerned downlink BWP (initial DL BWP in case of UE in RRC_IDLE), possible number of symbols between two adjacent PFs varies.

For example:
if:
   nAndPagingFrameOffset indicates oneT (e.g. every radio frame is PF); and
the SCS is 15 KHz,
the maximum number of PMOs between two adjacent PF is 140 (14 symbols per time slots and 10 time slots per radio frame; at most one PMO per symbol).
if:
   pagingAdaptationNAndPagingFrameOffset indicates oneThirtySecondT (e.g. PF occurs every 32 radio frames); and
the SCS is 480 KHz,
the maximum number of/PMOs between two adjacent PF is 143360 (14 symbols per time slot, 320 time slots per radio frame and 2 radio frames between adjacent PFs).

Taking all the possible cases in the consideration, table below lists the possible maximum number of PMOs in relation to pagingAdaptationNAndPagingFrameOffset.

Table 9 shows maximum Number of PMOs until the next PF for each CASEs

TABLE 9

| | pagingAdaptationNAndPagingFrameOffset | | | | | |
|---|---|---|---|---|---|---|
| SCS | oneT | halfT | quarterT | oneEighthT | oneSixteenthT | oneThirtySecondT |
| 15 | 140 | 280 | 560 | 1120 | 2240 | 4480 |
| 30 | 280 | 560 | 1120 | 2240 | 4480 | 8960 |
| 60 | 560 | 1120 | 2240 | 4480 | 8960 | 17920 |
| 120 | 1120 | 2240 | 4480 | 8960 | 17920 | 35840 |
| 240 | 2240 | 4480 | 8960 | 17920 | 35840 | 71680 |
| 480 | 4480 | 8960 | 17920 | 35840 | 71680 | 143360 |

Table 10 lists the possible maximum number of PMOs in relation to nAndPagingFrameOffset.

TABLE 10

| | nAndPagingFrameOffset | | | | |
|---|---|---|---|---|---|
| SCS | oneT | halfT | quarterT | oneEighthT | oneSixteenthT |
| 15 | 140 | 280 | 560 | 1120 | 2240 |
| 30 | 280 | 560 | 1120 | 2240 | 4480 |
| 60 | 560 | 1120 | 2240 | 4480 | 8960 |
| 120 | 1120 | 2240 | 4480 | 8960 | 17920 |
| 240 | 2240 | 4480 | 8960 | 17920 | 35840 |
| 480 | 4480 | 8960 | 17920 | 35840 | 71680 |

Each cell of table 9 and table 10 indicates the possible maximum number of PMOs in a specific case. For example, grey cell indicates the possible maximum number of PMOs in case that SCS is 60 KHz and pagingAdaptationNAndPagingFrameOffset is quarterT.

For simplicity, each case is numbered as below.

TABLE 11

| | pagingAdaptationNAndPagingFrameOffset | | | | | |
|---|---|---|---|---|---|---|
| SCS | oneT | halfT | quarterT | oneEighthT | oneSixteenthT | oneThirtySecondT |
| 15 | case1 | case2 | case3 | case4 | case5 | case6-1 |
| 30 | case2 | case3 | case4 | case5 | case6 | case7-1 |
| 60 | case3 | case4 | case5 | case6 | case7 | case8-1 |
| 120 | case4 | case5 | case6 | case7 | case8 | case9-1 |
| 240 | case5 | case6 | case7 | case8 | case9 | case10-1 |
| 480 | case6 | case7 | case8 | case9 | case10 | case11-1 |

TABLE 12

| | Max. value | Description |
|---|---|---|
| case1 | 140 | SCS15 KHZoneT |
| case2 | 280 | SCS30 KHZoneT or SCS15 KHZhalfT |
| case3 | 560 | SCS60 KHZoneT, SCS30 KHZhalfT or |
| | | SCS15 KHZquarterT |
| case4 | 1120 | SCS120 KHZoneT, SCS60 KHZhalfT, SCS30 KHZquarterT or |
| | | SCS15 KHZoneEighthT |
| case5 | 2240 | SCS240 KHZoneT, SCS120 KHZhalfT, SCS60 KHZquarterT, SCS30 KHZoneEighthT or |
| | | SCS15 KHZoneSixteenthT |
| case6-1 | 4480 | SCS15 KHZoneThirtySecondT |
| case6 | 4480 | SCS480 KHZoneT, SCS240 KHZhalfT, SCS120 KHZquarterT, SCS60 KHZoneEighthT or |
| | | SCS30 KHZoneSixteenthT |
| case7-1 | 8960 | SCS30 KHZoneThirtySecondT |
| case7 | 8960 | SCS480 KHZhalfT, SCS240 KHZquarterT, SCS120 KHZoneEighthT or |
| | | SCS60 KHZoneSixteenthT |
| case8-1 | 17920 | SCS60 KHZoneThirtySecondT |
| case8 | 17920 | SCS480 HZquarterT, SCS240 KHZoneEighthT or SCS120 KHZoneSixteenthT |
| case9-1 | 35840 | SCS120 KHZoneThirtySecondT |
| case9 | 35840 | SCS480 KHZoneEighthT or SCS240 KHZoneSixteenthT |
| case10-1 | 71680 | SCS240 KHZoneThirtySecondT |
| case10 | 71680 | SCS480 KHZoneSixteenthT |
| case11-1 | 143360 | SCS480 KHZoneThirtySecondT |

SCSxxYYY indicates the case where SCS of DL BWP is xx KHz and nAndPagingFrameOffset/pagingAdaptationNAndPagingFrameOffset indicates YYY.

firstPDCCH-MonitoringOccasionOfPO-xx is specified by CHOICE type which defines a union of multiple alternatives, where only one alternative can be selected and encoded in a given instance. Each alternative is identified by a name (e.g. case7) and associated with a specific data type (e.g. multiple of INTEGERs of which maximum value is 8959). These alternatives are mutually exclusive, ensuring that only one is active at any time.

Depending on the given case, firstPDCCH-MonitoringOccasionOfPO-xx includes an alternative corresponding to the given case. The specific alternative comprises one or more INTEGERs, wherein the maximum value of the INTEGER is equal to possible maximum PMOs (symbols) between adjacent PFs minus one in the given case. The number of INTEGER is equal to the value indicated by ns field or by pagingAdaptation-NS-r19 field. For example, if the cell is in one of case3 (e.g. SCS60 KHZoneT, SCS30 KHZhalfT or SCS15 KHZquarterT) and pagingAdaptation-NS-r19 field indicates 8, firstPDCCH-MonitoringOccasionOfPO-v1900 includes case3 alternative, and the case3 alternative comprises 8 INTEGERs, and the maximum value of the 8 INTEGERs is 559. The bitwidths of the 8 INTEGERs are 10 bit (that is smallest bitwidth that covers 559).

| | |
|---|---|
| firstPDCCH-MonitoringOccasionOfPO | CHOICE { |

| | |
|---|---|
| case1 | SEQUENCE (SIZE (1..maxPO-perPF)) OF INTEGER (0..139), |
| case2 | SEQUENCE (SIZE (1..maxPO-perPF)) OF INTEGER (0..279), |
| case3 | SEQUENCE (SIZE (1..maxPO-perPF)) OF INTEGER (0..559), |
| case4 | SEQUENCE (SIZE (1..maxPO-perPF)) OF INTEGER (0..1119), |
| case5 | SEQUENCE (SIZE (1..maxPO-perPF)) OF INTEGER (0..2239), |
| case6 | SEQUENCE (SIZE (1..maxPO-perPF)) OF INTEGER (0..4479), |
| case7 | SEQUENCE (SIZE (1..maxPO-perPF)) OF INTEGER (0..8959), |
| case8 | SEQUENCE (SIZE (1..maxPO-perPF)) OF INTEGER |

(0..17919)

| | | |
|---|---|---|
| } | OPTIONAL, | -- Need R |

firstPDCCH-MonitoringOccasionOfPO-v1710 CHOICE {

| | |
|---|---|
| case9 | SEQUENCE (SIZE (1..maxPO-perPF)) OF INTEGER |

(0..35839),

| | |
|---|---|
| case10 | SEQUENCE (SIZE (1..maxPO-perPF)) OF INTEGER |

(0..71679)

| | |
|---|---|
| } | OPTIONAL -- Need R |

firstPDCCH-MonitoringOccasionOfPO-v1900 CHOICE {

| | |
|---|---|
| case1 | SEQUENCE (SIZE (1..maxPO-perPFext)) OF INTEGER |

(0..139),

| | |
|---|---|
| case2 | SEQUENCE (SIZE (1..maxPO-perPFext)) OF INTEGER |

(0..279),

| | |
|---|---|
| case3 | SEQUENCE (SIZE (1..maxPO-perPFext)) OF INTEGER |

(0..559),

| | |
|---|---|
| case4 | SEQUENCE (SIZE (1..maxPO-perPFext)) OF INTEGER |

(0..1119),

| | |
|---|---|
| case5 | SEQUENCE (SIZE (1..maxPO-perPFext)) OF INTEGER |

(0..2239),

| | |
|---|---|
| case6or6-1 | SEQUENCE (SIZE (1..maxPO-perPFext)) OF |

INTEGER (0..4479),

| | |
|---|---|
| case7or7-1 | SEQUENCE (SIZE (1..maxPO-perPFext)) OF |

INTEGER (0..8959),

| | |
|---|---|
| case8or8-1 | SEQUENCE (SIZE (1..maxPO-perPFext)) OF |

INTEGER (0..17919)

| | |
|---|---|
| case9or9-1 | SEQUENCE (SIZE (1..maxPO-perPFext)) OF INTEGER |

(0..35839),

| | |
|---|---|
| case10or10-1 | SEQUENCE (SIZE (1..maxPO-perPFext)) OF |

INTEGER (0..71679),

| | |
|---|---|
| case11-1 | SEQUENCE (SIZE (1..maxPO-perPFext) OF INTEGER |

(0..143359))

| | | |
|---|---|---|
| } | OPTIONAL, | -- Need R |

```
  /// maxPO-perPF = maximum value that can be indicated by ns = 4///
  /// maxPO-perPFext = maximum value that can be indicated by pagingAdaptation-
NS = 8///
  }
```

UE uses firstPDCCH-MonitoringOccasionOfPO in case that:
the paging-adaptation is not applied to the UE in the cell, and the cell is in one of case1~case8; and
firstPDCCH-MonitoringOccasionOfPO is broadcast in the SIB1 of the cell.

UE uses firstPDCCH-MonitoringOccasionOfPO-v1710 in case that:
the paging-adaptation is not applied to the UE in the cell, and the cell is either in case9 or case10; and
firstPDCCH-MonitoringOccasionOfPO-v1710 is broadcast in the SIB1 of the cell.

UE uses firstPDCCH-MonitoringOccasionOfPO-v1900 in case that:
the paging-adaptation is applied to the UE in the cell; and
firstPDCCH-MonitoringOccasionOfPO-v1900 is broadcast in the SIB1 of the cell.

Number of INTEGERs (entries) in firstPDCCH-MonitoringOccasionOfPO and in firstPDCCH-MonitoringOccasionOfPO-v1710 are equal to the value indicated in ns field. For example, if ns field indicates 4, 4 INTEGERs are included in firstPDCCH-MonitoringOccasionOfPO. The first INTEGER indicates starting PMO for PO-index of 0 (i_s=0), the second INTEGER indicates starting PMO for PO-index of 1 (i_s=1) and so on.

Number of INTEGERs (entries) in firstPDCCH-MonitoringOccasionOfPO-v1900 is equal to the value indicated in pagingAdaptation-NS-r19 field. For example, if pagingAdaptation-NS-r19 field indicates 8, 8 INTEGERs are included in firstPDCCH-MonitoringOccasionOfPO-v1900. The first INTEGER indicates starting PMO for PO-index of 0 (i_s=0), the second INTEGER indicates starting PMO for PO-index of 1 (i_s=1) and so on.

### <Terminal Operations>

### /1: Baseline Scheme and Enhanced Scheme/

Paging scheme is determination based on NES paging indication in NAS message and NES paging indication in system information

Terminal performs followings:
transmitting by the terminal to AMF a message of a first protocol layer [NAS]
   the message comprises an IE indicating that the terminal supports NES paging (enhanced paging, enhanced paging scheme . . . )
receiving by the terminal from the AMF a message of the first protocol layer
   the message comprises an IE indicating that NES paging is allowed to the terminal in a one or more TAs (indicated by TAI list in the message)
receiving by the terminal from a base station a system information
determining by the terminal one or more PMOs
performing PDCCH monitoring for paging in the one or more PMOs
wherein:
the one or more PMOs are determined based on a first method in case that:
   NES paging is allowed by upper layers (e.g. NAS message comprising a first NES paging information has been received);
   NES paging is allowed by the base station in the cell (e.g. system information comprising a second NES paging information has been received);
the one or more PMOs are determined based on a second method in case that:
   NES paging is not allowed by upper layer (e.g. NAS message comprising the first NES paging indication has not been received); or
   NES paging is allowed by upper layer but NES paging is not allowed by the base station (or NES paging is not allowed in the cell).
In the first method:
   A specific frame is determined based on a first equation:
      Right side of the first equation:
         comprise ‘DRX cycle’ and ‘an integer derived from UE_ID [UE_ID]’ and ‘an integer derived from the DRX cycle (indicating the number of RPs during a DRX cycle)’ or ‘an integer which is same for a first specific group of UE IDs [UE_ID mod N]’
         does not comprise a dispersion factor.
   A group of PMOs [PO; PMOG] are determined based on an index of the group of PMOs and first PMO in the specific frame.
   The index of the group of PMOs is determined based on a second equation:
      Right side of the second equation:
         comprises ‘an integer which is same for a second specific group of UE IDs [UE_ID div N]’ and ‘an integer indicating number of PMO groups associated with a RP’;
   the one or more PMOs are selected from the group of PMOs based on RSRP of SSB,
In the second method:
   A specific frame is determined based on a third equation:
      Right side of the third equation:
         comprise ‘DRX cycle’ and ‘an integer derived from UE_ID [UE_ID]’ and ‘an integer derived from the DRX cycle (indicating the number of RPs during a DRX cycle)’ or ‘an integer which is same for a first specific group of UE IDs [UE_ID mod N]’
   The integer is a remainder of UE_ID divide N
      comprise a dispersion factor [T div N].
   The dispersion factor is a quotient of T divide N
   A group of PMOs [PO; PMOG] are determined based on an index of the group of PMOs and first PMO in the specific frame.
   The index of the group of PMOs is determined based on a second equation:
      Right side of the second equation:
   comprises an integer which is same for a second specific group of UE IDs [UE_ID div N] and an integer indicating number of PMO groups associated with a RP,
   the one or more PMOs are selected from the group of PMOs based on RSRP of SSB.

### /2: UE_ID GROUP/

Terminal performs followings:
transmitting by the terminal to a AMF a first message of a first protocol layer [NAS].
   the message comprises an IE/parameter indicating that the terminal supports NES paging (enhanced paging, enhanced paging scheme . . . ) for CN paging (or in RRC_IDLE state).
receiving by the terminal from the AMF a second message of the first protocol layer.
   the message comprises an IE/parameter indicating that NES paging is allowed in RRC_IDLE (or for CN paging).
transmitting by the terminal to a base station a third message [UECapability Information] of a second protocol layer.
   The third message comprises a field/parameter indicating that the terminal supports NES paging for RAN paging (or in RRC_INACTIVE state).
receiving by the terminal from the base station a fourth message [RRCRelease] of the second protocol layer.
   The fourth message comprises:
      a field/parameter indicating that NES paging is allowed in RRC_INACTIVE (or for RAN paging) in the RNA;
      a set of parameters related to RRC_INACTIVE state (e.g. SuspendConfig).
receiving by the terminal a system information.
   The system information comprises:
      An indication that NES paging is allowed in the cell for the UE in RRC_INACTIVE state
      a set of parameters related to NES paging;
determining by the terminal one or more PMOs; and
performing PDCCH monitoring for paging in the one or more PMOs.
To determine the one or more PMOs:
   A specific frame is determined based on a first equation:
      Right side of the first equation comprises:
         A first integer derived from UE_ID and N
   The first integer which is same/common for/to a first set of UE IDs [UE_ID mod N]
   A group of PMOs are determined based on:
      an index of the group of PMOs; and
      first PMO in the specific frame
   The index of the group of PMOs is determined based on a second equation:
      Right side of the second equation comprises:
         A second integer derived from UE_ID and N
   The Second integer is same/common for/to a second set of UE IDs [UE_ID div N]
   the one or more PMOs are selected from the group of PMOs based on RSRP of SSB

The specific frame is determined based on an integer relating to the first set of UE_IDs and the index of the PO is determined based on an integer relating to the second set of UE_IDs.

### /3: CN Paging/

Terminal performs followings:
transmitting by the terminal to a AMF a first message of a first protocol layer [NAS].
   the message comprises an IE/parameter indicating that the terminal supports NES paging (enhanced paging, enhanced paging scheme . . . ) for CN paging (or in RRC_IDLE state).
receiving by the terminal from the AMF a second message of the first protocol layer.
   the message comprises:
      an IE/parameter indicating that NES paging is allowed in RRC_IDLE (or for CN paging)
      a parameter for T_CN;
      a parameter for T_E_CN;
receiving by the terminal a system information.
   The system information comprises:
      An indication that NES paging is allowed in the cell for the UE in RRC_IDLE state for CN paging
      a set of parameters related to NES paging;
determining by the terminal one or more PMOs; and
performing PDCCH monitoring for paging in the one or more PMOs.
To determine the one or more PMOs:
   A specific frame is determined based on a first equation:
      Right side of the first equation comprises:
         an integer which is same for a first set of UE IDs [UE_ID mod N]
      Left side of the first equation comprises:
         T_E_CN in case that T_E_CN is equal to or smaller than 1024 radio frames
         The shortest of T_CN and T_D in case that T_E_CN is larger than 1024 radio frames
   A group of PMOs are determined based on:
      an index of the group of PMOs; and
      first PMO in the specific frame
   The index of the group of PMOs is determined based on a second equation:
      Right side of the second equation comprises:
         an integer derived from UE_ID and N
         The integer is same for a second set of UE IDs
the one or more PMOs are selected from the group of PMOs based on RSRP of SSB

### \4: RAN Paging/

Terminal performs followings:
At 4A10, the terminal transmits to a AMF a first message of a first protocol layer [NAS].
   the message comprises an IE/parameter indicating that the terminal supports paging-adaptation for CN paging (or in RRC_IDLE state).
At 4A20, the terminal receives from the AMF a second message of the first protocol layer.
   the message comprises:
      an IE/parameter indicating that paging-adaptation is allowed in RRC_IDLE (or for CN paging)
      a parameter for T_CN;
      a set of parameters for T_E_CN;
At 4A30, the terminal transmits to a base station a third message [UECapabilityInformation] of a second protocol layer.
   The third message comprises a field/parameter indicating that the terminal supports paging-adaptation for RAN paging (or in RRC_INACTIVE state).
At 4A40, the terminal receives from the base station a fourth message [RRCRelease] of the second protocol layer.
   The fourth message comprises:
      a field/parameter indicating that paging-adaptation is allowed in RRC_INACTIVE (or for RAN paging);
      a parameter for T_RAN;
      a set of parameters for T_E_RAN
a set of parameters related to RRC_INACTIVE state
At 4A50, the terminal receives a system information.
   The system information comprises:
      An indication that paging-adaptation is allowed in the cell;
      a set of parameters related to paging-adaptation;
At 4A60, the terminal determines one or more PMOs; and
At 4A70, the terminal performs PDCCH monitoring for paging in the one or more PMOs.
To determine the one or more PMOs:
   A specific frame is determined based on a first equation:
      Right side of the first equation comprises:
         A first_N and UE_ID
      Left side of the first equation comprises:
         A first_T and PF_offset
   A group of PMOs are determined based on:
      an index of the group of PMOs; and
      first PMO in the specific frame. The index of the first PMO is determined based on the set of parameters related to paging-adaptation;
   The index of the group of PMOs is determined based on a second equation:
      Right side of the second equation comprises:
         A second_N
   the one or more PMOs are selected from the group of PMOs based on RSRP of SSB.
The first_T and the first_N are same as the second_T and second_N in case that ranPagingInIdlePO is not comprised in SIB1.
In case that ranPagingInIdlePO is comprised in SIB1 and both T_E_CN and T_E_RAN are smaller than 1024 radio frames and the terminal operates in eDRX:
   The first_T is Shortest of [T_E_RAN, T_E_CN]; and
   The second Tis T_E_CN.
In case that ranPagingInIdlePO is comprised in SIB1 and T_E_CN is larger than 1024 radio frames and T_E_RAN is smaller than 1024 radio frames and the terminal operates in eDRX:
   The first Tis Shortest of [T_CN, T_E_RAN, T_D] during CN configured PTW and is T_E_RAN outside the CN configured PTW; and
   The second_T is shortest of [T_CN, T_D] during CN configured PTW and is T_E_RAN outside the CN configured PTW.

| /Message/IE/ | |
|---|---|
| DownlinkConfigCommonSIB ::= | SEQUENCE { |
| bcch-Config | BCCH-Config, |
| pcch-Config | PCCH-Config, |

}

| | |
|---|---|
| BCCH-Config ::= | SEQUENCE { |
| modificationPeriodCoeff | ENUMERATED {n2, n4, n8, n16}, |

...
}

| | |
|---|---|
| PCCH-Config ::= | SEQUENCE { |
| defaultPagingCycle | PagingCycle, |
| nAndPagingFrameOffset | CHOICE { |

| | |
|---|---|
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| ns | ENUMERATED {four, two, |

one},

| | |
|---|---|
| firstPDCCH-MonitoringOccasionOfPO | CHOICE { |

| | |
|---|---|
| case1 | SEQUENCE (SIZE (1..maxPO-perPF)) OF INTEGER (0..139), |

| | | |
|---|---|---|
| case2 | SEQUENCE (SIZE (1..maxPO-perPF)) OF | INTEGER |

(0..279),

| | | |
|---|---|---|
| case3 | SEQUENCE (SIZE (1..maxPO-perPF)) OF | INTEGER |

(0..559),

| | | |
|---|---|---|
| case4 | SEQUENCE (SIZE (1..maxPO-perPF)) OF | INTEGER |

(0..1119),

| | | |
|---|---|---|
| case5 | SEQUENCE (SIZE (1..maxPO-perPF)) OF | INTEGER |

(0..2239),

| | | |
|---|---|---|
| case6 | SEQUENCE (SIZE (1..maxPO-perPF)) OF | INTEGER |

(0..4479),

| | | |
|---|---|---|
| case7 | SEQUENCE (SIZE (1..maxPO-perPF)) OF | INTEGER |

(0..8959),

| | | |
|---|---|---|
| case8 | SEQUENCE (SIZE (1..maxPO-perPF)) OF | INTEGER |

(0..17919)

| | | |
|---|---|---|
| } | OPTIONAL, | -- Need R |

| | |
|---|---|
| nrofPDCCH-MonitoringOccasionPerSSB-InPO-r16 | INTEGER |

(2..4)
ranPagingInIdlePO-r17
ENUMERATED {true}

| | |
|---|---|
| firstPDCCH-MonitoringOccasionOfPO-v1710 | CHOICE { |

| | | |
|---|---|---|
| case9 | SEQUENCE (SIZE (1..maxPO-perPF)) OF | INTEGER |

(0..35839),

| | | |
|---|---|---|
| case10 | SEQUENCE (SIZE (1..maxPO-perPF)) OF | INTEGER |

(0..71679)
}

| | |
|---|---|
| pagingAdaptation-NS-r19 | ENUMERATED {eight,four, two, one} |

| | |
|---|---|
| pagingAdaptationNAndPagingFrameOffset | CHOICE { |

| | |
|---|---|
| oneT | NULL, |
| halfT | INTEGER (0..1), |
| quarterT | INTEGER (0..3), |
| oneEighthT | INTEGER (0..7), |
| oneSixteenthT | INTEGER (0..15), |
| oneThirtySecondT | INTEGER (0..31) |

}

]]

firstPDCCH-MonitoringOccasionOfPO-v1900 CHOICE {

| | |
|---|---|
| case1 | SEQUENCE (SIZE (1..maxPO-perPFext)) OF INTEGER |

(0..139),

| | |
|---|---|
| case2 | SEQUENCE (SIZE (1..maxPO-perPFext)) OF INTEGER |

(0..279),

| | |
|---|---|
| case3 | SEQUENCE (SIZE (1..maxPO-perPFext)) OF INTEGER |

(0..559),

| | |
|---|---|
| case4 | SEQUENCE (SIZE (1..maxPO-perPFext)) OF INTEGER |

(0..1119),

| | |
|---|---|
| case5 | SEQUENCE (SIZE (1..maxPO-perPFext)) OF INTEGER |

(0..2239),

| | |
|---|---|
| case6or6-1 | SEQUENCE (SIZE (1..maxPO-perPFext)) OF |

INTEGER (0..4479),

| | |
|---|---|
| case7or7-1 | SEQUENCE (SIZE (1..maxPO-perPFext)) OF |

INTEGER (0..8959),

| | |
|---|---|
| case8or8-1 | SEQUENCE (SIZE (1..maxPO-perPFext)) OF |

INTEGER (0..17919)

| | |
|---|---|
| case9or9-1 | SEQUENCE (SIZE (1..maxPO-perPFext)) OF INTEGER |

(0..35839),

| | |
|---|---|
| case10or10-1 | SEQUENCE (SIZE (1..maxPO-perPFext)) OF |

INTEGER (0..71679),

| | |
|---|---|
| case11 | SEQUENCE (SIZE (1..maxPO-perPFext) OF INTEGER |

(0..143359))

| | | |
|---|---|---|
| } | OPTIONAL, | -- Need R |

```
  /// maxPO-perPF = maximum value that can be indicated by ns = 4///
  /// maxPO-perPFext = maximum value that can be indicated by pagingAdaptation-
NS = 8///
  }
```

bcch-Config: The modification period related configuration.

pcch-Config: The paging related configuration.

modificationPeriodCoeff: Actual modification period, expressed in number of radio frames m=modificationPeriodCoeff*defaultPagingCycle. n2 corresponds to value 2, n4 corresponds to value 4, and so on.

defaultPagingCycle: Default paging cycle, used to derive ‘T’. Value rf32 corresponds to 32 radio frames, value rf64 corresponds to 64 radio frames and so on.

firstPDCCH-MonitoringOccasionOfPO: Points out the first PDCCH monitoring occasion for paging of each PO of the PF.

pagingAdaptation-NS: Number of paging occasions per paging frame for paging adaptation.

pagingAdaptationNAndPagingFrameOffset: Used to derive the number of total paging frames in T and paging frame offset (corresponding to parameter PF_offset). A value of oneSixteenthT corresponds to T/16, a value of oneEighthT corresponds to T/8, and so on.

nAndPagingFrameOffset: Used to derive the number of total paging frames in T (corresponding to parameter N) and paging frame offset (corresponding to parameter PF_offset). A value of oneSixteenthT corresponds to T/16, a value of oneEighthT corresponds to T/8, and so on.

nrofPDCCH-MonitoringOccasionPerSSB-InPO: The number of PDCCH monitoring occasions corresponding to an SSB within a Paging Occasion.

ns: Number of paging occasions per paging frame.

ranPagingInIdlePO: Indicates that the network supports to send RAN paging in PO that corresponds to the i_s as determined by UE in RRC_IDLE state.

### /REGISTRATION REQUEST/

The REGISTRATION REQUEST message is sent by the UE to the AMF. The message comprises:
Requested DRX parameters that contains 5GS DRX parameters
Requested extended DRX parameters contains Extended DRX parameters
NES paging support. If this IE is included, UE supports enhanced scheme for paging (e.g. NES paging)

### /REGISTRATION ACCEPT/

The REGISTRATION ACCEPT message is sent by the AMF to the UE. The message comprises:
Negotiated DRX parameters that contains 5GS DRX parameters;
Negotiated extended DRX parameters that contains Extended DRX parameters;
NES-paging-allowed. If included, UE consider enhanced scheme for paging (e.g. NES paging) is used in a cell that supports the enhanced scheme.

### 5GS DRX Parameters IE

5GS DRX parameters information element indicates that the UE wants to use DRX and for the network to indicate the DRX cycle value to be used at paging. The IE comprises DRX value field. This field represents the DRX cycle parameter ‘T’. This value is denoted T_CN.

### Extended DRX Parameters IE

Extended DRX parameters information element indicate that the UE wants to use eDRX and for the network to indicate the Paging Time Window length value and the extended DRX cycle value to be used for eDRX. eDRX value field indicates T_E_CN. Paging Time Window field indicates PTW.

When extended DRX (eDRX) is used, the following applies:
For RRC_INACTIVE, eDRX configuration for RAN paging is decided and configured by NG-RAN. In RRC_INACTIVE the UE monitors both RAN and CN paging;
For RRC_IDLE, eDRX for CN paging is configured by upper layers. In RRC_IDLE the UE monitors only CN paging;
Information on whether eDRX for CN paging and RAN paging is allowed on the cell is provided separately in system information;
The maximum value of the eDRX cycle is 10485.76 seconds (2.91 hours) while the minimum value of the eDRX cycle is 2.56 seconds;
The hyper SFN (H-SFN) is broadcast by the cell and increments by one when the SFN wraps around;
Paging Hyperframe (PH) refers to the H-SFN in which the UE starts monitoring paging according to DRX during a Paging Time Window (PTW). The PH and PTW are determined based on a formula (see TS 38.304 [10]) that is known by the AMF, UE and NG-RAN;
H-SFN, PH and PTW are used if the eDRX cycle is greater than 10.24 seconds;
When the RRC_IDLE eDRX cycle is longer than the system information modification period, the UE verifies that stored system information remains valid before resuming/establishing an RRC connection.

If the UE does not operate in eDRX:
T is determined by the shortest of the UE specific DRX value configured by RRC (if any), the UE specific DRX value configured by upper layers (if any), and a default DRX value broadcast in system information. For L2 U2N Relay UE, T for a L2 U2N Remote UE is determined by the shortest of the UE specific DRX value provided in PC5-RRC signalling and a default DRX value broadcast in system information.

In RRC_IDLE state, if the UE operates in eDRX and eDRX is configured by upper layers, i.e., T_eDRX_CN, according to clause 7.4:
If T_eDRX_CN is no longer than 1024 radio frames:
   T=T_eDRX_CN;
else:
   During CN configured PTW, T is determined by the shortest of UE specific DRX value, if configured by upper layers, and the default DRX value broadcast in system information.

In RRC_INACTIVE state, if the UE operates in eDRX and eDRX is configured by RRC, i.e., T_eDRX_RAN (if any), and upper layers, i.e., T_eDRX_CN:
If both T_eDRX_CN and used T_eDRX_RAN are no longer than 1024 radio frames, T=min {T_eDRX_RAN, T_eDRX_CN}.
If T_eDRX_CN is no longer than 1024 radio frames and no T_eDRX_RAN is configured or used, T is determined by the shortest of UE specific DRX value configured by RRC and T_eDRX_CN.
If T_eDRX_CN is longer than 1024 radio frames:
   If T_eDRX_RAN is not configured or used:
      During CN configured PTW, T is determined by the shortest of the UE specific DRX value configured by RRC, the UE specific DRX value configured by upper layers (if any), and a default DRX value broadcast in system information. Outside the CN configured PTW, T is determined by the UE specific DRX value configured by RRC;
   else if used T_eDRX_RAN is no longer than 1024 radio frames:
      During CN configured PTW, T is determined by the shortest of the UE specific DRX value, if configured by upper layers and T_eDRX_RAN, and a default DRX value broadcast in system information. Outside the CN configured PTW, T is determined by T_eDRX_RAN;
   else if used T_eDRX_RAN is longer than 1024 radio frames:
      During the overlapped part of CN configured PTW and RAN configured PTW, T is determined by the shortest of the UE specific DRX value configured by RRC, the UE specific DRX value configured by upper layers (if any), and a default DRX value broadcast in system information;
      During CN configured PTW and outside RAN configured PTW, T is determined by the shortest of the UE specific DRX value configured by upper layers (if any), and a default DRX value broadcast in system information;
      Outside CN configured PTW and during RAN configured PTW, T is determined by the UE specific DRX value configured by RRC.

N: number of total paging frames in T

Ns: number of paging occasions for a PF

PF_offset: offset used for PF determination

UE_ID:

If the UE operates in eDRX as specified in clause 7.4:
5G-S-TMSI mod 4096

else:
5G-S-TMSI mod 1024

The UE may be configured by upper layers and/or RRC with an extended DRX (eDRX) cycle T_eDRX_CN and/or T_eDRX_RAN.

For CN paging, the UE operates in eDRX in RRC_IDLE or RRC_INACTIVE states if the UE is configured for eDRX by upper layers and eDRX-AllowedIdle is signalled in SIB1; otherwise, the UE does not operate in eDRX.

For RAN paging, the UE in RRC_INACTIVE state:
if the UE is configured for eDRX by ran-ExtendedPagingCycle-r18 and eDRX-AllowedInactive-r18 is signalled in SIB1:
operates in eDRX with an eDRX cycle T_eDRX_RAN configured by extendedPagingCycle-r18;
else if the UE is configured for eDRX by ran-ExtendedPagingCycle-r17 and eDRX-AllowedInactive-r17 is signalled in SIB1:
operates in eDRX with an eDRX cycle T_eDRX_RAN configured by ran-ExtendedPagingCycle-r17;
else:
does not operate in eDRX.

If the UE operates in eDRX with an eDRX cycle no longer than 1024 radio frames, it monitors POs as defined in 7.1 with configured eDRX cycle. Otherwise, a UE operating in eDRX monitors POs as defined in 7.1 during a periodic Paging Time Window (PTW) configured for the UE. The PTW is UE-specific and is determined by a Paging Hyperframe (PH), a starting position within the PH (PTW_start) and an ending position (PTW_end). PH, PTW_start and PTW_end are given by the following formula:

The PH for CN is the H-SFN satisfying the following equations:

H-SFN mod T_eDRX_CN=(UE_ID_H mod T_eDRX_CN), where
T_eDRX_CN: UE-specific eDRX cycle in Hyper-frames, (T_eDRX_CN=2, . . . , 1024 Hyper-frames) configured by upper layers.

The PH for RAN is the H-SFN satisfying the following equations:

H-SFN mod T_{eDRX_RAN}=(UE_ID_H mod T_{eDRX_RAN}), where
T_{eDRX_RAN}: UE-specific eDRX cycle in Hyper-frames, (T_{eDRX_RAN}=2, . . . , 1024 Hyper-frames) configured by RRC.

For CN configured PTW:

PTW_start denotes the first radio frame of the PH for CN that is part of the PTW and has SFN satisfying the following equation:

SFN=128*i_eDRX_CN, where
i_eDRX_CN=floor(UE_ID_H/T_eDRX_CN)mod 8

PTW_end is the last radio frame of the PTW and has SFN satisfying the following equation:

SFN=(PTW_start+L*100−1)mod 1024, where
L=Paging Time Window (PTW) length (in seconds) configured by upper layers

For RAN configured PTW:

PTW_start denotes the first radio frame of the PH for RAN that is part of the PTW and has SFN satisfying the following equation:

SFN=128*i_{eDRX_CN}, where
i_{eDRX_CN}=floor(UE_ID_H/TeDRX_CN)mod 8

PTW_end is the last radio frame of the PTW and has SFN satisfying the following equation:

SFN=(PTW_start+L*100−1)mod 1024, where
L=Paging Time Window (PTW) length (in seconds) configured by RRC

UE_ID His defined as follows:

UE_ID_H: 13 most significant bits of the Hashed ID.

Hashed ID is defined as follows:

Hashed_ID is Frame Check Sequence (FCS) for the bits b31, b30 . . . , b0 of 5G-S-TMSI.

5G-S-TMSI=<b47, b46, . . . , b0> as defined in TS 23.003 [23].

The 32-bit FCS shall be the ones complement of the sum (modulo 2) of Y1 and Y2, where Y1 and Y2 are defined in TS 38.304.

For a UE supporting paging adaptation, if pagingAdaptation-NS and pagingAdaptationNAndPagingFrameOffset are signalled in system information, it derives the value of N and PF_offset from the parameter pagingAdaptationNAndPagingFrameOffset and only monitors the PO(s) derived from these paging parameters.

For a UE supporting paging adaptation, if pagingAdaptation-NS and pagingAdaptationNAndPagingFrameOffset are signalled in system information, it determines i_s from the parameter pagingAdaptation-NS and N. UE determines the POs based on i_s and firstPDCCH-MonitoringOccasionOfPO. UE monitors the determined PO(s).

If the UE has no 5G-S-TMSI, for instance when the UE has not yet registered onto the network, the UE shall use as default identity UE_ID=0 in the PF and i_s formulas above.

5G-S-TMSI is a 48 bit long bit string. 5G-S-TMSI shall in the formulae above be interpreted as a binary number where the left most bit represents the most significant bit. It is signalled in REGISTRATION ACCEPT message.

In RRC_INACTIVE state, if the UE supports inactiveStatePO-Determination and the network broadcasts ranPagingInIdlePO with value “true”, the UE shall use the same i_s as for RRC_IDLE state. Otherwise, the UE determines the i_s based on the parameters and formula above.

In RRC_INACTIVE state, if used eDRX value configured by upper layers is no longer than 1024 radio frames, the UE shall use the same i_s as for RRC_IDLE state for CN paging and RAN-initiated paging.

In RRC_INACTIVE state, if used eDRX value configured by upper layers is longer than 1024 radio frames, during CN PTW, the UE shall use the same i_s as for RRC_IDLE state for CN paging and RAN-initiated paging. Outside CN PTW, the UE shall use the i_s for RRC_INACTIVE state for CN paging and RAN-initiated paging.

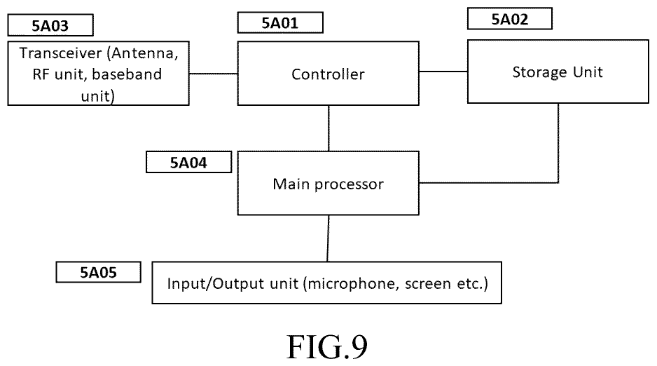

FIG. 9 is a block diagram illustrating the internal structure of a Terminal to which the disclosure is applied.

Referring to the diagram, the terminal includes a controller (5A01), a storage unit (5A02), a transceiver (5A03), a main processor (5A04) and I/O unit (5A05).

The controller (5A01) controls the overall operations of the terminal in terms of mobile communication. For example, the controller (5A01) receives/transmits signals through the transceiver (5A03). In addition, the controller (5A01) records and reads data in the storage unit (5A02). To this end, the controller (5A01) includes at least one processor. For example, the controller (5A01) may include a communication processor (CP) that performs control for communication and an application processor (AP) that controls the upper layer, such as an application program. The controller controls storage unit and transceiver such that UE operations illustrated in this disclosure are performed.

The storage unit (5A02) stores data for operation of the terminal, such as a basic program, an application program, and configuration information. The storage unit (5A02) provides stored data at a request of the controller (5A01).

The transceiver (5A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down—converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (5A04) controls the overall operations other than mobile operation. The main processor (5A04) process user input received from I/O unit (5A05), stores data in the storage unit (5A02), controls the controller (5A01) for required mobile communication operations and forward user data to I/O unit (5A05).

I/O unit (5A05) consists of equipment for inputting user data and for outputting user data such as a microphone and a screen. I/O unit (5A05) performs inputting and outputting user data based on the main processor's instruction.

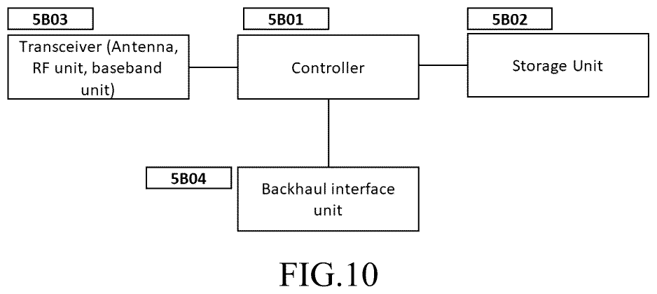

FIG. 10 is a block diagram illustrating the configuration of a base station according to the disclosure.

As illustrated in the diagram, the base station includes a controller (5B01), a storage unit (5B02), a transceiver (5B03) and a backhaul interface unit (5B04).

The controller (5B01) controls the overall operations of the main base station. For example, the controller (5B01) receives/transmits signals through the transceiver (5B03), or through the backhaul interface unit (5B04). In addition, the controller (5B01) records and reads data in the storage unit (5B02). To this end, the controller (5B01) may include at least one processor. The controller controls transceiver, storage unit and backhaul interface such that base station operation illustrated in this disclosure are performed.

The storage unit (5B02) stores data for operation of the main base station, such as a basic program, an application program, and configuration information. Particularly, the storage unit (5B02) may store information regarding a bearer allocated to an accessed UE, a measurement result reported from the accessed UE, and the like. In addition, the storage unit (5B02) may store information serving as a criterion to determine whether to provide the terminal with multi-connection or to discontinue the same. In addition, the storage unit (5B02) provides stored data at a request of the controller (5B01).

The transceiver (5B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down—converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (5B04) provides an interface for communicating with other nodes inside the network. The backhaul interface unit (5B04) converts a bit string transmitted from the base station to another node, for example, another base station or a core network, into a physical signal, and converts a physical signal received from the other node into a bit string.

Below lists acronym used in the present disclosure.

| | |
|---|---|
| 5GC | 5G Core Network |
| ACK | Acknowledgement |
| AM | Acknowledged Mode |
| AMF | Access and Mobility Management Function |
| RA-RNTI | Random Access RNTI |
| ARQ | Automatic Repeat Request |
| AS | Access Stratum |
| ASN.1 | Abstract Syntax Notation One |
| BSR | Buffer Status Report |
| BWP | Bandwidth Part |
| CA | Carrier Aggregation |
| CAG | Closed Access Group |
| CG | Cell Group |
| C-RNTI | Cell RNTI |
| CSI | Channel State Information |
| DCI | Downlink Control Information |
| DRB | (user) Data Radio Bearer |
| DTX | Discontinuous Reception |
| HARQ | Hybrid Automatic Repeat Request |
| SDAP | Service Data Adaptation Protocol |
| IE | Information element |
| LCG | Logical Channel Group |
| MAC | Medium Access Control |
| MIB | Master Information Block |
| NAS | Non-Access Stratum |
| NG-RAN | NG Radio Access Network |
| NR | NR Radio Access |
| PBR | Prioritised Bit Rate |
| PCell | Primary Cell |
| PCI | Physical Cell Identifier |
| PDCCH | Physical Downlink Control Channel |
| SSS | Secondary Synchronisation Signal |
| PDCP | Packet Data Convergence Protocol |
| PDSCH | Physical Downlink Shared Channel |
| TM | Transparent Mode |
| PDU | Protocol Data Unit |
| PHR | Power Headroom Report |
| PLMN | Public Land Mobile Network |
| PRACH | Physical Random Access Channel |
| CRP | Cell Reselection Priority |
| PRB | Physical Resource Block |
| PUCCH | Physical Uplink Control Channel |
| PUSCH | Physical Uplink Shared Channel |
| RACH | Random Access Channel |
| RAN | Radio Access Network |
| RAR | Random Access Response |
| RAT | Radio Access Technology |
| RB | Radio Bearer |
| RLC | Radio Link Control |
| RNA | RAN-based Notification Area |
| RNAU | RAN-based Notification Area Update |
| RNTI | Radio Network Temporary Identifier |
| RRC | Radio Resource Control |
| RRM | Radio Resource Management |
| RSRP | Reference Signal Received Power |
| RSRQ | Reference Signal Received Quality |
| RSSI | Received Signal Strength Indicator |
| SCell | Secondary Cell |
| SCS | Subcarrier Spacing |
| SDU | Service Data Unit |
| SFN | System Frame Number |
| S-GW | Serving Gateway |
| SI | System Information |
| SIB | System Information Block |
| SpCell | Special Cell |
| SRB | Signalling Radio Bearer |
| SRS | Sounding Reference Signal |
| SS | Search Space |
| SSB | SS/PBCH block |
| SUL | Supplementary Uplink |
| UCI | Uplink Control Information |
| UE | User Equipment |
| UM | Unacknowledged Mode |
| PSS | Primary Synchronisation Signal |

What is claimed is:

1. A terminal in a wireless communication system, the terminal comprising:
a transceiver configured to transmit and receive signals; and
a controller configured to control the transceiver to:
receive, from a base station, system information, wherein the system information comprises at least:
a first parameter for number of paging occasions; and
a first parameter for paging frame offset; and
monitor at least one monitoring occasion of a specific set of consecutive monitoring occasions,
wherein:
in case that first specific conditions are fulfilled, a starting monitoring occasion number of the specific set of consecutive monitoring occasions is determined based on a second parameter related to a first monitoring occasion;
in case that second specific conditions are fulfilled, the starting monitoring occasion number of the specific set of consecutive monitoring occasions is determined based on a first parameter related to the first monitoring occasion,
wherein the first specific conditions comprise:
the system information comprising the second parameter related to the first monitoring occasion; and
paging adaptation being applied, and
wherein the second specific conditions comprise at least the system information comprising the first parameter related to the first monitoring occasion.

2. The terminal of claim 1,
wherein the second specific conditions further comprise paging adaptation not being applied.

3. The terminal of claim 1,
wherein, in case that the system information further comprises a second parameter for number of paging occasions and a second parameter for paging frame offset:
a paging frame is determined based on the second parameter for paging frame offset; and
an index of a paging occasion is determined based on the second parameter for number of paging occasions.

4. The terminal of claim 3,
wherein, in case that the system information does not comprise the second parameter for number of paging occasions and the second parameter for paging frame offset:
the paging frame is determined based on the first parameter for paging frame offset; and
the index of the paging occasion is determined based on the first parameter for number of paging occasions.

5. The terminal of claim 1, wherein:
the first parameter related to the first monitoring occasion comprises a plurality of first integers;
number of the first integers is equal to a value determined based on the first parameter for number of paging occasions;
the second parameter related to the first monitoring occasion comprises a plurality of second integers; and
number of the second integers is equal to a value determined based on the second parameter for number of paging occasions.

6. The terminal of claim 5, wherein:
a maximum value of the second integers is determined based on a specific subcarrier spacing and a value indicated by the second parameter for paging frame offset.
